(19) United States
(12) Patent Application Publication
(10) Pub. No.: US 2022/0416260 A1
(43) Pub. Date: Dec. 29, 2022

(54) HYBRID CATALYST SUITABLE FOR USE IN PROTON EXCHANGE MEMBRANE FUEL CELL

(71) Applicants: The Research Foundation for The State University of New York, Buffalo, NY (US); Giner, Inc., Newton, MA (US)

(72) Inventors: Gang Wu, Clarence Center, NY (US); Yachao Zeng, Buffalo, NY (US); Zhi Qiao, Bryan, TX (US); Hui Xu, Acton, MA (US); Shuo Ding, Boston, MA (US)

(21) Appl. No.: 17/849,275

(22) Filed: Jun. 24, 2022

Related U.S. Application Data
(60) Provisional application No. 63/214,629, filed on Jun. 24, 2021.

(51) Int. Cl. H01M 4/92; H01M 4/88; H01M 8/1004

(52) U.S. Cl. CPC H01M 4/926; H01M 4/8882; H01M 8/1004; H01M 2004/8689

(57) ABSTRACT

Hybrid catalyst suitable for use in a proton exchange membrane fuel cell and method of preparing same. In one embodiment, the hybrid catalyst is iron-free and includes an Mn—N—C support and platinum-containing nanoparticles that are dispersed on the Mn—N—C support. The Mn—N—C support preferably comprises atomically dispersed and nitrogen coordinated MnN₄ moieties and has a particle size of about 30 to 200 nm. The platinum-containing nanoparticles preferably have a particle size ranging from about 2 to 8 nm and are made of platinum or a platinum-cobalt intermetallic alloy, such as a cubic L1₂ Pt₃Co alloy or a tetragonal L1₀ PtCo alloy. The hybrid catalyst may be made by combining a quantity of a hexachloroplatinic acid solution with a quantity of an Mn—N—C support, sonicating the mixture in an ice bath, freeze-drying the sonicated product, calcinating the freeze-dried product under a forming gas, and heating the calcinated product.

### CROSS-REFERENCE TO RELATED APPLICATIONS

The present application claims the benefit under 35 U.S.C. 119(e) of U.S. Provisional Patent Application No. 63/214,629, inventors Gang Wu et al., filed Jun. 24, 2021, the disclosure of which is incorporated herein by reference in its entirety.

### FEDERALLY SPONSORED RESEARCH OR DEVELOPMENT

This invention was made with government support under DOE DE-EE0008075 Cooperative Agreement entitled “Durable Mn-Based PGM-Free Catalysts for Polymer Electrolyte Membrane Fuel Cells” awarded by the US Department of Energy. The government has certain rights in the invention.

### BACKGROUND OF THE INVENTION

The present invention relates generally to catalysts for the oxygen reduction reaction in proton exchange membrane fuel cells and relates more particularly to a novel such catalyst.

Fuel cells, particularly proton exchange membrane (PEM) fuel cells, represent a promising sustainable and clean energy conversion technology for a number of different applications including, but not limited to, the field of transportation. In a PEM fuel cell, the chemical energy of a fuel, typically hydrogen, and of an oxidizing agent, typically oxygen, is converted into electricity through a pair of redox reactions. Where oxygen is used as the oxidizing agent, the redox reaction involving oxygen is often referred to as the oxygen reduction reaction and typically results in the reduction of oxygen to water. As can be appreciated, the oxygen reduction reaction represents a critical process in the operation of a PEM fuel cell and requires an effective and durable catalyst to attain efficient energy conversion. Typically, platinum-group metals (i.e., platinum and five other noble, precious metal elements clustered with platinum in the periodic table) have been used as such a catalyst, and such metals have shown promising performance and durability in real applications. Unfortunately, however, the high cost and scarcity of platinum-group metals have limited their large-scale deployment in PEM fuel cells and have driven efforts to reduce the usage of platinum-group metals in fuel cell catalysts.

One such approach to reducing the usage of platinum-group metals has been to alloy platinum with a first-row transition metal (M), such as cobalt, nickel, or iron. Because first-row transition metal atoms have a smaller atomic radius than does platinum, incorporating such metal atoms into a platinum-based alloy brings beneficial strain and alloy effects that are significant to optimize O₂/intermediates adsorption and to improve the intrinsic oxygen reduction reaction activity. Compared to the common solid solution Al-structure, which is disordered, certain platinum-metal (PtM) alloys with specific Pt/M compositions can form ordered intermetallic structures, including a cubic L1₂ (Pt₃M) and a tetragonal L1₀ (PtM). These types of ordered intermetallic structures are attributed to a negative enthalpy change often derived from a strong 3d-5d orbital interaction between M and Pt, which enables stabilization of M. Compared to traditional fcc Pt alloys, an ordered intermetallic structure results in less M leaching and improved stability under acidic fuel cell conditions. Unlike the disordered A1-structure, the cubic L1₂ and the tetragonal L1₀ structures usually are obtained by thermal annealing at high temperatures (>700° C.). However, an agglomeration of nanoparticles at such high temperatures can result in large particle sizes, which do not provide adequate electrochemically active surface areas, thus limiting performance at high current density.

Another approach for reducing platinum usage in catalysts has been to try to develop a platinum group metal (PGM)-free catalyst. Generally, such catalysts are prepared from earth-abundant elements, such as atomically dispersed metal (M: Fe and Co) single sites coordinated with nitrogen and embedded within a carbon matrix, thereby creating M—N—C catalysts. More specifically, the production of such M—N—C catalysts typically includes two stages, namely, the synthesis of a catalyst precursor and, then, the high temperature treatment or carbonization of the catalyst precursor to form active sites to be occupied by MN₄ moieties. See, for example, Zhang et al., “Engineering nanostructures of PGM-free oxygen-reduction catalysts using metal-organic frameworks,” Nano Energy, 31:331-350 (2017), which is incorporated herein by reference. Current M—N—C catalysts are typically derived from zinc-based zeolitic imidazolate frameworks (ZIFs), a subfamily of metal-organic frameworks (MOFs). An example of a ZIF is 2-methylimidazole zinc salt (ZIF-8), which is typically in crystal form. ZIF-8-derived carbon materials synthesized via carbonization at high temperature (e.g., 1100° C.) possess an abundance of micropores and defects.

Some of the more promising M—N—C catalysts are derived from Fe and ZIF-8 precursors and demonstrate encouraging oxygen reduction reaction activity that approaches that of platinum catalysts. In such catalysts, the FeN₄ moieties, which are believed to be the oxygen reduction reaction active sites, are dispersed uniformly throughout the carbon matrix. Unfortunately, however, the insufficient stability of these iron-containing catalysts during proton exchange membrane fuel cell (PEMFC) operation has been a significant drawback, severely limiting the viability of an approach involving PGM-free catalysts.

Documents that may be of interest may include the following, all of which are incorporated herein by reference: U.S. Patent Application Publication No. US 2022/0069315 A1, inventors Wu et al., published Mar. 3, 2022; U.S. Patent Application Publication No. US 2022/0190356 A1, inventors Wu et al., published Jun. 16, 2022; PCT International Publication No. WO 2022/015888 A2, published Jan. 20, 2022; Chen et al., “High-Platinum-Content Catalysts on Atomically Dispersed and Nitrogen Coordinated Single Manganese Site Carbons for Heavy-Duty Fuel Cells,” Journal of The Electrochemical Society, 169(3):034510 (March 2022); and Qiao et al., “Atomically dispersed single iron sites for promoting Pt and Pt₃Co fuel cell catalysts: performance and durability improvements,” Energy Environ. Sci., 14:4948-4960 (2021).

### SUMMARY OF THE INVENTION

It is an object of the present invention to provide a novel catalyst suitable for use in the oxygen reduction reaction in a proton exchange membrane fuel cell.

It is another object of the present invention to provide a catalyst as described above that overcomes at least some of the shortcomings associated with at least some of the existing catalysts for use in the oxygen reduction reaction in a proton exchange membrane fuel cell.

Therefore, according to one aspect of the invention, there is provided a hybrid catalyst suitable for use in an oxygen reduction reaction in a proton exchange membrane fuel cell, the hybrid catalyst comprising (a) a support, the support comprising an Mn—N—C support; and (b) platinum-containing nanoparticles dispersed on the Mn—N—C support.

In a more detailed feature of the invention, the Mn—N—C support may comprise atomically dispersed and nitrogen coordinated MnN₄ moieties.

In a more detailed feature of the invention, the platinum-containing nanoparticles may have a particle size ranging from about 2 to 8 nm.

In a more detailed feature of the invention, the Mn—N—C support may have a particle size ranging from about 30 to 200 nm.

In a more detailed feature of the invention, the platinum-containing nanoparticles may be present with a loading ranging from about 10 to 60 wt. % against the Mn—N—C support.

In a more detailed feature of the invention, the platinum-containing nanoparticles may be present with a loading ranging from about 20 to 40 wt. % against the Mn—N—C support.

In a more detailed feature of the invention, the platinum-containing nanoparticles may be present with a loading of about 20 wt. % against the Mn—N—C support.

In a more detailed feature of the invention, the platinum-containing nanoparticles may be present with a loading of about 40 wt. % against the Mn—N—C support.

In a more detailed feature of the invention, the platinum-containing nanoparticles may comprise nanoparticles of a platinum alloy.

In a more detailed feature of the invention, the platinum alloy may be a platinum-cobalt alloy.

In a more detailed feature of the invention, the platinum-cobalt alloy may be a platinum-cobalt intermetallic alloy.

In a more detailed feature of the invention, the platinum-cobalt intermetallic alloy may be a cubic L1₂ Pt₃Co alloy.

In a more detailed feature of the invention, the platinum-cobalt intermetallic alloy may be a tetragonal L1₀ PtCo alloy.

In a more detailed feature of the invention, the platinum-containing nanoparticles may be platinum nanoparticles.

In a more detailed feature of the invention, the Mn—N—C support may further comprise a sulfur dopant.

In a more detailed feature of the invention, the Mn—N—C support may be devoid of a dopant other than the platinum-containing nanoparticles.

According to another aspect of the invention, there is provided a membrane electrode assembly suitable for use in a proton exchange membrane fuel cell, the membrane electrode assembly comprising (a) a proton exchange membrane, the proton exchange membrane having first and second faces on opposite sides; (b) a cathode operatively coupled to the first face of the proton exchange membrane, the cathode comprising the above-described hybrid catalyst; and (c) an anode operatively coupled to the second face of the proton exchange membrane.

According to yet another aspect of the invention, there is provided a method of preparing a hybrid catalyst comprising platinum nanoparticles dispersed on an Mn—N—C support, the method comprising the steps of (a) combining a quantity of a hexachloroplatinic acid solution with a quantity of an Mn—N—C support to form a mixture; (b) sonicating the mixture in an ice bath; (c) then, freeze-drying the product of step (b); (d) then, calcinating the product of step (c) under a forming gas; and (e) then, heating the product of step (d).

According to still yet another aspect of the invention, there is provided a method of preparing a hybrid catalyst comprising nanoparticles of a cubic L1₂ Pt₃Co alloy dispersed on an Mn—N—C support, the method comprising the steps of (a) combining quantities of a hexachloroplatinic acid solution, CoCl₂.6H₂O, and an Mn—N—C support to form a mixture; (b) sonicating the mixture in an ice bath; (c) then, freeze-drying the product of step (b); (d) then, calcinating the product of step (c) under a forming gas; (e) then, heating the product of step (d); (f) then, leaching the product of step (e) in perchloric acid; (g) then, vacuum-drying the product of step (f); and (h) then, post-treating the product of step (g) at an elevated temperature under argon.

According to a further aspect of the invention, there is provided a method of preparing a hybrid catalyst comprising nanoparticles of a tetragonal L1₀ PtCo alloy dispersed on an Mn—N—C support, the method comprising the steps of (a) combining quantities of a hexachloroplatinic acid solution, CoCl₂.6H₂O, and an Mn—N—C support to form a mixture; (b) sonicating the mixture in an ice bath to form a homogeneous complex suspension; (c) then, quickly freezing the product of step (b), followed by freeze-drying overnight; (d) then, heating the product of step (c) under forming gas flow; (e) then, allowing the product of step (d) to cool to room temperature; (f) then, heating the product of step (e) under forming gas; (g) then, leaching the product of step (f) in perchloric acid; and (h) then, post-treating the product of step (g) at an elevated temperature under argon.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. These drawings are not necessarily drawn to scale, and certain components may have undersized and/or oversized dimensions for purposes of explication or may omit certain features for purposes of clarity. In the drawings wherein like reference numerals represent like parts:

FIG. 1 is a simplified front view of a first embodiment of a membrane electrode assembly constructed according to the present invention;

FIG. 2 is a simplified front view of a second embodiment of a membrane electrode assembly constructed according to the present invention;

FIG. 3A is a high-resolution transmission electron microscopy (HR-TEM) image of a hybrid catalyst of the present invention, namely, Pt@HS Mn—N—C-600, which is discussed in Example 1;

FIG. 3B is a graph depicting the size distribution of platinum nanoparticles in the hybrid catalyst of FIG. 3A;

FIG. 3C is an abbreviation-corrected high-angle annular dark-field transmission electron microscopy (HAADF TEM) image of the hybrid catalyst of FIG. 3A;

FIG. 3D is a graph depicting electron energy loss spectra (EELS) acquired in the position circled in FIG. 3C, indicating that the dispersed atoms are manganese atoms;

FIG. 4A is a graph depicting the adsorption profiles for various Mn—N—C catalysts that are discussed in Example 1;

FIG. 4B is a graph depicting the porosity distributions of the various Mn—N—C catalysts of FIG. 4A;

FIG. 4C is a graph depicting X-ray diffraction (XRD) patterns of the various Mn—N—C catalysts of FIG. 4A, in which only diffraction peaks corresponding to the C(002) and C(101) panels can be observed, indicating the dispersion efficacy of metal atoms in an N-doped carbon matrix;

FIG. 4D is a graph depicting Raman spectra of the various Mn—N—C catalysts of FIG. 4A, in which a low ratio of intensity of D peak to G peak has been observed, indicating a high graphitization degree of the catalysts;

FIG. 5A is high-resolution transmission electron microscopy (HR-TEM) image of ultrafine L1₂ Pt₃Co intermetallics dispersed on an HS Mn—NC-1100 support, wherein Pt₃Co nanoparticles with a size less than 10 nm can be observed;

FIG. 5B is an high-angle annular dark-field transmission electron microscopy (abbreviation—corrected HAADF TEM) image of L1₂ Pt₃Co@HS Mn—NC-800, in which atomically dispersed Mn with high density can be observed in the carbon matrix;

FIG. 6A is a graph depicting cyclic voltammograms for the oxygen reduction reaction (ORR) performance of various atomically dispersed Ni, Co, and Mn catalyst supports loaded with 20 wt. % platinum, with platinum nanoparticles supported on ZIF-NC-1100 serving as a reference, as discussed in Example 2;

FIG. 6B is a graph depicting the electrochemically active surface areas (ECSAs) of the prepared catalysts of FIG. 6A;

FIG. 6C is a graph depicting the oxygen reduction reaction (ORR) performance of the catalysts of FIG. 6A in O₂-saturated 0.1 M HClO₄, wherein the linear scanning rate is 5 mV s⁻¹, the rotation speed is 1600 rpm, and the platinum loading in the disk electrode is 20.0 μg cm_{geo}⁻²;

FIG. 6D is a graph depicting the H₂O₂ yield and apparent electron transfer number in the oxygen reduction reaction process for the catalysts of FIG. 6A;

FIG. 6E is a graph depicting the Tafel profiles and slopes of the catalysts of FIG. 6A derived from the Koutecky-Levich equations;

FIG. 6F is a graph comparing the mass specific and active surface area specific activities of the catalysts of FIG. 6A using different single atom catalysts supports;

FIG. 7A is a graph depicting cyclic voltammograms for the oxygen reduction reaction (ORR) performance of various Mn catalyst supports loaded with 20 wt. % platinum that are discussed in Example 2;

FIG. 7B is a graph depicting the electrochemically active surface areas (ECSAs) of the prepared catalysts of FIG. 7A;

FIG. 7C is a graph depicting the oxygen reduction reaction (ORR) performance of the catalysts of FIG. 7A in O₂-saturated 0.1 M HClO₄, wherein the linear scanning rate is 5 mV s⁻¹ and the platinum loading in the disk electrode is 20.0 μg cm_{geo}⁻²;

FIG. 7D is a graph depicting the Tafel profiles and slopes of the catalysts of FIG. 7A derived from the Koutecky-Levich equations;

FIG. 7E is a graph comparing the mass specific and active surface area specific activities of the catalysts of FIG. 7A using different single atom catalysts supports;

FIG. 8A is a graph depicting cyclic voltammograms for the oxygen reduction reaction (ORR) performance of Pt@HS Mn—NC catalysts annealed at 600° C., 700° C., 800° C., and 900° C., as discussed in Example 2;

FIG. 8B is a graph depicting the electrochemically active surface areas (ECSAs) of the prepared catalysts of FIG. 8A;

FIG. 8C is a graph depicting the oxygen reduction reaction (ORR) performance of the catalysts of FIG. 8A in O₂-saturated 0.1 M HClO₄, wherein the linear scanning rate is 5 mV s⁻¹ and the platinum loading in the disk electrode is 20.0 μg cm_{geo}⁻²;

FIG. 8D is a graph depicting X-ray diffraction (XRD) profiles of the catalysts of FIG. 8A;

FIG. 9A is a graph depicting the oxygen reduction reaction (ORR) performance of various catalysts discussed in Example 3 in O₂-saturated 0.1 M HClO₄, wherein the linear scanning rate is 5 mV s⁻¹, the rotating speed is 1600 rpm, and the platinum loading in the disk electrode is 20.0 μg cm_{geo}⁻², the electron transfer numbers evaluated by detecting H₂O₂ yield on a ring electrode;

FIG. 9B is a graph depicting the Tafel profiles and slopes of the catalysts of FIG. 9A derived from the Koutecky-Levich equations;

FIG. 9C is a graph comparing the mass specific and active surface area specific activities of the catalysts of FIG. 9A;

FIGS. 9D and 9E are graphs depicting the single cell performance of Pt@HS Mn—NC-600 and L1₂ Pt₃Co@HS Mn—NC-800, respectively, recorded during an accelerated stress test;

FIG. 9F is a graph depicting the mass activities (H₂—O₂, @0.9 V_{iR-free}) and voltage loss (@0.8 A cm⁻²) during an accelerated stress test in a single cell;

FIG. 10A is a graph depicting cyclic voltammograms of the Pt/C (20 wt. %, JM), Pt@HS Mn—NC-600, and L1₂ Pt₃Co@HS Mn—NC-800 catalysts discussed in Example 3;

FIG. 10B is a graph comparing the electrochemically active surface areas (ECSAs) of the catalysts of FIG. 10A;

FIG. 10C is a graph comparing the oxygen reduction reaction performance of Pt@HS Mn—NC-600 at different rotation speeds in O₂-saturated 0.1 M HClO₄, wherein the linear scanning rate is 5 mV s⁻¹ and the Pt loading in the disk electrode is 20.0 μg cm_{geo}⁻²;

FIG. 10D is a Koutechy-Levich plot for Pt@HS Mn—NC-600;

FIG. 10E is a graph comparing the oxygen reduction reaction performance of L1₂ Pt₃Co@HS Mn—NC-800 at different rotation speeds in O₂-saturated 0.1 M HClO₄, wherein the linear scanning rate is 5 mV s⁻¹ and the Pt loading in the disk electrode is 20.0 μg cm_{geo}⁻²;

FIG. 10F is a Koutechy-Levich plot for L1₂ Pt₃Co@HS Mn—NC-800;

FIGS. 11A and 11B are transmission electron microscopy (TEM) images of the L1₀ PtCo@HS Mn—NC-700 catalyst discussed in Example 3;

FIG. 11C is a graph depicting the crystal structure of L1₀ PtCo@HS Mn—NC-700 as revealed by XRD (X-ray diffraction);

FIG. 11D is a graph depicting a linear scanning voltammogram for L1₀ PtCo@HS Mn—N—C-700;

FIG. 11E is a graph depicting the mass activity and specific activity of L1₀ PtCo@HS Mn—NC-700 at 0.85 V_{RHE} and 0.90 V_{RHE};

FIG. 11F is a graph depicting the results of an accelerated durability test for L1₀ PtCo@HS Mn—NC-700;

FIG. 12A is a high-resolution transmission electron microscopy (HR-TEM) image of the Pt (40 wt. %)/Mn—N—C catalyst discussed in Example 4;

FIG. 12B is a graph depicting the size distribution of platinum nanoparticles in the Pt (40 wt. %)/Mn—N—C catalyst of FIG. 12A;

FIG. 12C is a high-resolution transmission electron microscopy (HR-TEM) image of the Pt (40 wt. %)/Mn—N—C catalyst discussed in Example 4;

FIG. 12D is a secondary electron image of the Pt (40 wt. %)/Mn—N—C catalyst discussed in Example 4;

FIGS. 12E, 12F and 12G are scanning transmission electron microscopy images of the Pt (40 wt. %)/Mn—N—C catalyst discussed in Example 4;

FIG. 13A is a transmission electron microscopy (TEM) image of the Pt (40 wt. %)/PGC catalyst discussed in Example 4;

FIG. 13B is a graph depicting the size distribution of platinum nanoparticles in the Pt (40 wt. %)/PGC catalyst of FIG. 13A;

FIG. 13C is a transmission electron microscopy (TEM) image of the Pt (40 wt. %)/PGC catalyst discussed in Example 4;

FIG. 13D is a scanning transmission electron microscopy image of the Pt (40 wt. %)/PGC catalyst discussed in Example 4;

FIGS. 13E and 13F are high-resolution transmission electron microscopy (HR-TEM) images of the Pt (40 wt. %)/PGC catalyst discussed in Example 4;

FIG. 13G is a secondary electron image of the Pt (40 wt. %)/PGC catalyst discussed in Example 4;

FIG. 14A is a graph depicting the X-ray diffraction patterns of the Pt (40 wt. %)/Mn—N—C; Pt (40 wt. %)/PGC, and Pt (40 wt. %)/C catalysts discussed in Example 4;

FIG. 14B is a graph depicting the Raman spectra of the Pt (40 wt. %)/Mn—N—C; Pt (40 wt. %)/PGC, and Pt (40 wt. %)/C catalysts discussed in Example 4;

FIG. 14C is a graph depicting the X-ray photoelectron spectroscopy (XPS) measurements for platinum 4 f of the Pt (40 wt. %)/Mn—N—C; Pt (40 wt. %)/PGC, and Pt (40 wt. %)/C catalysts discussed in Example 4;

FIG. 14D is a graph depicting the X-ray photoelectron spectroscopy (XPS) measurements for nitrogen 1 s of the Pt (40 wt. %)/Mn—N—C; Pt (40 wt. %)/PGC, and Pt (40 wt. %)/C catalysts discussed in Example 4;

FIG. 15A is a graph comparing linear sweep voltammetry curves of the Pt (40 wt. %)/Mn—N—C; Pt (40 wt. %)/PGC, and Pt (40 wt. %)/C catalysts, as discussed in Example 4;

FIG. 15B is a graph comparing cyclic voltammetry curves of the Pt (40 wt. %)/Mn—N—C; Pt (40 wt. %)/PGC, and Pt (40 wt. %)/C catalysts, as discussed in Example 4;

FIGS. 15C, 15D, and 15E are polarization curves, before and after a potential cycling test, for Pt/Mn—N—C, Pt/PGC, and Pt/C TKK catalysts, respectively, as discussed in Example 4;

FIG. 15F is a graph depicting the electrochemical surface areas of the Pt/Mn—N—C, Pt/PGC, and Pt/C TKK catalysts, before and after a durability test, as discussed in Example 4;

FIGS. 16A and 16B are secondary electron and medium-angle annular dark-field-scanning transmission electron microscopy images, respectively, of the Pt (40 wt. %)/Mn—N—C catalyst before an accelerated stress test, as discussed in Example 4;

FIG. 16C is a graph depicting the size distribution of platinum nanoparticles in the Pt (40 wt. %)/Mn—N—C catalyst of FIG. 16B;

FIGS. 16D and 16E are secondary electron and medium-angle annular dark-field-scanning transmission electron microscopy images, respectively, of the Pt (40 wt. %)/Mn—N—C catalyst after an accelerated stress test, as discussed in Example 4;

FIG. 16F is a graph depicting the size distribution of platinum nanoparticles in the Pt (40 wt. %)/Mn—N—C catalyst of FIG. 16E;

FIGS. 16G and 16H are secondary electron and medium-angle annular dark-field-scanning transmission electron microscopy images, respectively, of the Pt (40 wt. %)/PGC catalyst before an accelerated stress test, as discussed in Example 4;

FIG. 16I is a graph depicting the size distribution of platinum nanoparticles in the Pt (40 wt. %)/PGC catalyst of FIG. 16H;

FIGS. 16J and 16K are secondary electron and medium-angle annular dark-field-scanning transmission electron microscopy images, respectively, of the Pt (40 wt. %)/PGC catalyst after an accelerated stress test, as discussed in Example 4;

FIG. 16L is a graph depicting the size distribution of platinum nanoparticles in the Pt (40 wt. %)/PGC catalyst of FIG. 16K;

FIGS. 16M and 16N are secondary electron and medium-angle annular dark-field-scanning transmission electron microscopy images, respectively, of the Pt (40 wt. %)/C catalyst before an accelerated stress test, as discussed in Example 4;

FIGS. 16O is a graph depicting the size distribution of platinum nanoparticles in the Pt (40 wt. %)/C catalyst of FIG. 16N;

FIGS. 16P and 16Q are secondary electron and medium-angle annular dark-field-scanning transmission electron microscopy images, respectively, of the Pt (40 wt. %)/C catalyst after an accelerated stress test, as discussed in Example 4;

FIG. 16R is a graph depicting the size distribution of platinum nanoparticles in the Pt (40 wt. %)/C catalyst of FIG. 16Q;

FIG. 17A is a graph depicting fuel cell membrane electrode assembly (MEA) performance under H₂/air condition for Pt (40 wt. %)/Mn—N—C; Pt (40 wt. %)/PGC, and Pt (40 wt. %)/C catalysts discussed in Example 4, the performance being assessed at the beginning of life (BOL);

FIG. 17B is a graph depicting fuel cell MEA performance for the three catalysts of FIG. 17A at the end of life (EOL) after 30,000 voltage cycles using the trapezoidal wave method from 0.6 V to 0.95 V with 0.5 s rise time and 2.5 s hold time (150 kPa, H₂/N₂, 80° C., 100% relative humidity, 200/200 sccm);

FIG. 17C is a graph comparing the performance degradation for the three catalysts of FIG. 17A with respect to current density at 0.7 V and peak power density;

FIG. 17D is a graph depicting MEA performance of a Pt (40 wt. %)/Mn—N—C membrane electrode assembly under various relative humidity conditions;

FIGS. 18A and 18B are graph depicting the MEA performance of a Pt (40 wt. %)/Mn—N—C membrane electrode assembly after various accelerated stress test cycles; and

FIG. 18C is a graph depicting the mass specific activity and electrochemically active surface area (ECSA) as a function of accelerated stress test cycles for the MEA of FIG. 18.

### DETAILED DESCRIPTION OF THE INVENTION

The present invention is based, at least in part, on the discovery of a novel catalyst that is suitable for use in an electrochemical cell, such as, but not limited to, a proton exchange membrane fuel cell. More specifically, the present invention is based, at least in part, on the discovery that such a catalyst may be a hybrid catalyst and that said hybrid catalyst may comprise a carbon-based Mn—N—C catalyst (sometimes alternatively referred to herein as an Mn—NC catalyst) that may be used as a support for dispersed platinum or platinum-alloy nanoparticles. The aforementioned Mn—N—C support may be desirable in that it may provide platinum group metal (PGM)-free active sites (e.g., MnN₄ sites) that may serve to reduce platinum loading in an oxygen reduction reaction (ORR) cathode. In addition, the nitrogen dopants of the Mn—N—C support may stabilize dispersed platinum nanoparticles with strengthened metal-support interactions. Moreover, the possible synergy between platinum and PGM-free MnN₄ sites at the atomic level could lead to performance enhancement.

Therefore, according to one aspect of the present invention, a hybrid catalyst suitable for use as an oxygen reduction reaction catalyst in a proton exchange membrane fuel cell may be made by integrating platinum group metal-containing nanoparticles (PGM NPs) and MnN₄ site-rich Mn—N—C carbon with high surface area, the combination of which may be denoted herein as Pt@HS Mn—N—C, where the platinum group metal-containing nanoparticles are platinum nanoparticles, or, alternatively, as PtₓCo_{y}@HS Mn—N—C, where the platinum group metal-containing nanoparticles are platinum-cobalt alloy nanoparticles.

As will be discussed further below, MnN₄ in carbon is highly effective in dramatically enhancing platinum and platinum-cobalt (Pt—Co) catalyst performance. More specifically, the favorable porous carbon structure of MnN₄—C and its abundant nitrogen doping enable a uniform Pt—Co nanoparticle distribution, presenting average particle sizes of 3.0 nm for L1₂ intermetallic nanoparticles. Unlike the large particle sizes of ordered PtCo intermetallics, the use of the MnN₄ site-rich Mn—N—C carbon can significantly reduce particle size while achieving a defined ordered structure. The Pt@HS Mn—N—C and Pt₃Co@HS Mn—N—C hybrid catalysts of the present invention show excellent performance and durability in rotating disk electrode (RDE) and membrane electrode assembly (MEA) studies. Compared to traditional carbon black-supported Pt catalysts (Pt/C), a Pt@HS Mn—N—C hybrid catalyst of the present invention may achieve a significantly improved oxygen reduction reaction mass activity (MA) of 0.43 A/mg_{Pt} and may retain 83.7% of the initial value after 30,000 accelerated stress test (AST) voltage cycles in an MEA with low cathode loading of 0.1 mg_{Pt} cm⁻², thereby approaching U.S. Department of Energy (DOE) 2020 targets without using an alloy. Furthermore, a Pt₃Co@HS Mn—N—C hybrid catalyst of the present invention may achieve an even higher oxygen reduction reaction mass activity of 0.58 A mg_{Pt}⁻¹. In fact, a Pt₃Co@HS Mn—N—C catalyst of the present invention may reach a power density of 1132 mW cm⁻² at 0.67 V, exceeding the DOE target transportation application of 1.0 W cm⁻².

In view of the above, the hybrid catalysts of the present invention may comprise two components, namely, (i) an Mn—N—C support; and (ii) platinum-containing nanoparticles dispersed on the Mn—N—C support. Additional information concerning these two components is provided below.

The Mn—N—C support may be similar or identical to the Mn—N—C support disclosed in U.S. Patent Application Publication No. US 2022/0069315 A1, inventors Wu et al., published Mar. 3, 2022 and/or in Chen et al., “Atomically Dispersed MnN₄ Catalysts via Environmentally Benign Aqueous Synthesis for Oxygen Reduction: Mechanistic Understanding of Activity and Stability Improvements,” ACS Catalysis, 10(18):10523-10534 (2020), both of which are incorporated herein by reference.

More specifically, according to one embodiment of the invention, the Mn—N—C support may be prepared by a method that first comprises preparing an Mn-doped ZIF-8 precursor. The Mn-doped ZIF-8 precursor preferably is prepared using one or more aqueous solvents, such as an acid solution, which may be, for example, a hydrochloric acid/water solution or a nitric acid/water solution, and preferably is devoid of any organic solvents. For example, the Mn-doped ZIF-8 precursor may be prepared, for example, by reacting (a) a first solution comprising zinc nitrate hexahydrate (Zn(NO₃)₂.6H₂O) and manganese chloride (MnCl₂) dissolved in a hydrochloric acid/water solution with (b) a second solution comprising 2-methylimidazole dissolved in water. The molar ratio of Mn²⁺ to Zn²⁺ used for the synthesis can range from greater than 0 up to about 10%. Preferably, the molar ratio among MnCl₂, Zn(NO₃)₂.6H₂O, and 2-methylimidazole is about 0.015:1:47, respectively. The particle size of the Mn/ZIF precursor may be adjusted by modifying the concentration of chemicals in the synthesis reaction. For example, the concentration of Zn²⁺ in the aqueous solution may be adjusted at 66.9 mmol l⁻¹, 96.1 mmol l⁻¹, and 122.8 mmol l⁻¹ to prepare Mn catalysts with 30 nm, 85 nm, and 200 nm particle sizes, respectively. In other words, as the molar ratio of water to Zn²⁺ decreases, the catalyst particle size increases.

After collecting the precipitate by centrifugation, followed by washing with alcohol, the precipitate may be dried, for example, by heating at 60° C. in an oven overnight.

Next, the Mn-doped ZIF-8 precursor may be thermally activated (i.e., carbonized). The thermal activation may take place in a single pyrolysis step, such as by heating at an elevated temperature, such as 1100° C., or may take place in a multi-step pyrolysis process, such as by heating at a first temperature (e.g., 600° C.-1000° C.) for a first interval and then heating at a second temperature, which may be a higher temperature (e.g., 900° C.-1100° C.) for a second interval. Preferably, the foregoing heating takes place in an argon atmosphere.

After the aforementioned carbonization has taken place, the catalyst material may optionally be subjected to further processing. In one embodiment, such further processing may comprise an absorption process, followed by a second thermal activation step. The absorption process may comprise, for example, dispersing the catalyst material in a solution, wherein the solution may comprise manganese chloride and urea in a solvent comprising hydrochloric acid and isopropanol, preferably in equal amounts. Next, the solution may be ultrasonicated for a period of time, such as 30 minutes, and then may be subjected to magnetic stirring for a period of time, such as two hours. Next, the mixture may be subjected to centrifugation and then dried, for example, at 60° C. in a vacuum oven for 12 hours. The second thermal activation step may be conducted, for example, at a temperature of 1100° C. in an argon atmosphere for one hour.

The Mn—N—C support of the present invention may be in particulate form and may have a particle size ranging from about 30 nm to about 200 nm.

A specific example of a protocol for making such a support may be as follows: First, a mass of 33.9 g of 2-methylimidazole may be dissolved in 80 mL of deionized water to produce a Solution A. Then, masses of 2.631 g of Zn(NO)₂.6H₂O and 16.0 mg of MnCl₂ may be dissolved in a mixture of 0.5 mL of 2 M HCl solution and 10.5 mL of H₂O to produce a Solution B. Then, Solution B may be added into Solution A under stirring, and stirring may be continued for 6 hours. The reaction may then be kept at room temperature. Next, the white product may be centrifuged out at 9000 rpm, and the Mn-ZIF-8 may be washed with methanol 5 times. All of the precipitant may be collected and dried at 60° C. in a vacuum oven for 12 hours. The dried white powder may then be finely ground and heated at 800° C. in a tube furnace under N₂ flow for 2 hours. Then, the tube furnace may be heated to 1100° C. within 30 minutes. Pyrolysis at 1100° C. for 1 hour may occur; then, the product may be allowed to cool down to room temperature naturally. A mass of 40.0 mg of the thus prepared Mn—N—C may be combined with a mass of 200.0 mg of urea and a mass of 40.0 mg of MnCl₂ in a glass vial. Next, 2.0 mL of 0.25M HCl and 2.0 mL of IPA may be added to the vial. Next, the mixture may be ultrasonicated for 1 hour and then stirred for another 2 hours. Next, the Mn—N—C adsorbed with urea and MnCl₂ may be centrifuged out, and the product may be vacuum-dried overnight at 60° C. A mass of 40 mg of Mn—N—C adsorbed with urea and MnCl₂ may be added into a crucible boat and then pyrolyzed in Ar at 1100° C. for 1 hour. The as-prepared Mn—N—C may be denoted “HS Mn—N—C-1100,” in which the prefix “HS” refers to high surface area. The suffix “1100,” as used in Mn—N—C-1100, as well as similar suffixes used throughout the present application, refers to a thermal activation or pyrolysis temperature used in the fabrication of the support. HS Mn—N—C-1100 is especially referred to the Mn—N—C prepared by the method mentioned above, as its surface area is higher than 1200 m² g_{cat}⁻¹.

For purposes of the present invention, Mn—N—C supports may include, in addition to the platinum-containing nanoparticles, one or more dopants, an example of which may include sulfur. An example of such a support may be Mn—S—N—C-1100, in which thiourea may be used as a precursor to dope the Mn—N—C matrix with sulfur. Other types of Mn—N—C supports may include Mn—N—C x3AC-1100 and 125-0.12Mn—N—C x4AC-1100, both of which are prepared by a solid synthesis strategy. More specifically, Mn—N—C x3AC-1100 may use MnO₂ as a manganese source and also may use an ammonium chloride post-treatment. By contrast, 125-0.12Mn—N—C x4AC-1100 may use Mn-doped ZnO₂ nanoparticles as a manganese source and also may use an ammonium chloride post-treatment.

The platinum-containing nanoparticles of the present invention may have a particle size ranging from about 2 nm to about 8 nm. In addition, the platinum-containing nanoparticles of the present invention may be present in the hybrid catalyst with loadings ranging from about 10 to 60 wt. % (e.g., 40 wt. %) against the Mn—N—C-support.

In one embodiment, the platinum-containing nanoparticles of the present invention may consist of or may comprise nanoparticles of platinum. As an example, according to one embodiment, a catalyst comprising such nanoparticles of platinum may be made, for example, by a forming gas reduction method (10 vol. % H₂ balanced with argon) with a controlled platinum loading (e.g., 20 wt. %). More specifically, 2.43 mL hexachloroplatinic acid solution (10.0 g L⁻¹) may be dropped into a glass vial containing 36.0 mg of an Mn—N—C support. The mixture may then be sonicated in an ice bath for 1 h and then freeze-dried for 12 hours. The fine powder may be transferred into a crucible boat, and the precursor calcinated at 200° C. for 6 hours (10 min reach to 200° C.) under forming gas. Then, the temperature may be ramped to 600° C. and held for 1 h (30 min reach to 600° C.). Such catalysts may be denoted herein as Pt@Mn—N—C-600. For comparison, the catalysts may alternatively be annealed at 700° C., 800° C. or 900° C., with such catalysts being denoted according to the thermal annealing temperatures.

In another embodiment, the platinum-containing nanoparticles may consist of or may comprise nanoparticles of a platinum alloy. The platinum alloy may be a platinum-cobalt alloy and, more particularly, may be a platinum-cobalt intermetallic alloy. For example, and without limitation, the platinum-cobalt intermetallic alloy may be a cubic L1₂ Pt₃Co alloy or may be a tetragonal L1₀ PtCo alloy.

Where the platinum-cobalt intermetallic alloy is a cubic L1₂ Pt₃Co alloy, a catalyst comprising such an alloy may be made, for example, by a forming gas reduction method (10 vol. % H₂ balanced with argon) with a controlled platinum loading (e.g., 20 wt. %). More specifically, 2.43 mL hexachloroplatinic acid solution (10.0 g L⁻) and 60 μL CoCl₂.2H₂O (150.0 g L⁻¹) may be dropped into a glass vial containing 38.5 mg of an Mn—N—C support. The mixture may be sonicated in an ice bath for 1 h and then freeze-dried for 12 hours. The fine powder may then be transferred into a crucible boat, and the precursor calcinated at 350° C. for 2 hours (30 min reach to 350° C.) under forming gas. Then, the temperature may be ramped to 800° C. and held for 2 hours (25 min reach to 800° C.). The product may then be leached in 0.1M HClO₄ at 60° C. for 12 hours and then vacuum-dried at 60° C. for 12 hours. The leached product may then be post-treated at 400° C. under argon for 1 hour to obtain the final catalyst. Such a catalyst may be denoted herein as L1₂ Pt₃Co@Mn—N—C-800.

Where the platinum-cobalt intermetallic alloy is a tetragonal L1₀ PtCo alloy, a catalyst comprising such an alloy may be made, for example, by a forming gas reduction method (10 vol. % H₂ balanced with argon) with a controlled platinum loading (e.g., 20 wt. %). More specifically, 2.505 mL hexachloroplatinic acid solution (10 mg/mL) may be dropped into a vial containing 37.0 mg HS Mn—N—C-1100 and 27.5 mg CoCl₂.6H₂O. The mixture may be sonicated in an ice bath for 1 hour to form a homogeneous complex suspension. The suspension may then be quickly frozen with liquid nitrogen, followed by freeze-drying overnight. The dried powder may then be heated at 350° C. in a tube furnace under forming gas flow for 2 hours. After cooling down to 25° C., the furnace may be reheated to 750° C. for another 3 hours under forming gas for ordering L1₀ PtCo intermetallic structures. The resulting powder may be leached by 0.1M HClO₄ at 60° C. for 6 hours and post-treated at 400° C. under argon to obtain the final catalyst.

As will be discussed further below, the hybrid catalyst of the present invention may be used to make a membrane electrode assembly (MEA), such as, but not limited to an MEA of the type comprising a proton exchange membrane. For example, in one embodiment, an MEA of the type that comprises a proton exchange membrane and that is suitable for use in a fuel cell may be fabricated as follows: An ink may be prepared, the ink comprising the hybrid catalyst of the present invention and one or more suitable ionomers. The ink may then be directly applied, for example, by spray-coating, painting, or any other suitable technique, to one surface of the proton exchange membrane. The ink may then be fused to the proton exchange membrane by hot-pressing or any other suitable technique, thereby forming a catalyst coating directly on the proton exchange membrane. Said coating may serve, for example, as the cathode for the oxygen reduction reaction of a fuel cell. A suitable catalyst coating that may be used as the anode for the hydrogen oxidization reaction of a fuel cell may be directly applied and fused in an analogous fashion to the opposite surface of the proton exchange membrane. The foregoing membrane electrode assembly may be regarded as being of the membrane electrode assembly type commonly referred to in the art as a catalyst coated membrane.

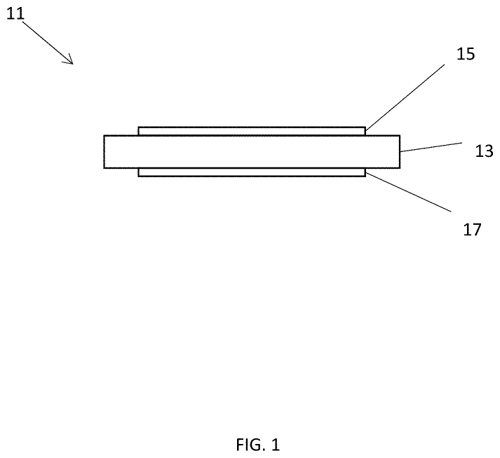

Referring now to FIG. 1, there is shown a simplified front view of one embodiment of a membrane electrode assembly constructed according to the present invention, the membrane electrode assembly being represented generally by reference numeral 11. (For simplicity and clarity, certain components of membrane electrode assembly 11 that are not critical to the understanding of the present invention are either not shown or described herein or are shown and/or described herein in a simplified manner.)

Membrane electrode assembly (MEA) 11, which may be suitable for use in, for example, a fuel cell or other electrochemical cell, may be regarded as a catalyst coated membrane. MEA 11 may comprise a proton exchange membrane (also sometimes referred to as a solid polymer electrolyte membrane) (PEM) 13. PEM 13 is preferably a non-porous, ionically-conductive, electrically-non-conductive, liquid permeable and substantially gas-impermeable membrane. PEM 13 may consist of or comprise a homogeneous perfluorosulfonic acid (PFSA) polymer. Said PFSA polymer may be formed by the copolymerization of tetrafluoroethylene and perfluorovinylether sulfonic acid. See e.g., U.S. Pat. No. 3,282,875, inventors Connolly et al., issued Nov. 1, 1966; U.S. Pat. No. 4,470,889, inventors Ezzell et. al., issued Sep. 11, 1984; U.S. Pat. No. 4,478,695, inventors Ezzell et. al., issued Oct. 23, 1984; U.S. Pat. No. 6,492,431, inventor Cisar, issued Dec. 10, 2002; and U.S. Pat. No. 9,595,727 B2, inventors Mittelsteadt et al., issued Mar. 14, 2017, all of which are incorporated herein by reference in their entireties. A commercial embodiment of a PFSA polymer electrolyte membrane is manufactured by The Chemours Company FC, LLC (Fayetteville, N.C.) as NAFION™ extrusion cast PFSA polymer membrane.

MEA 11 may further comprise a cathode 15 and an anode 17. Cathode 15 and anode 17 may be positioned along two opposing major faces of PEM 13. In the present embodiment, cathode 15 is shown positioned along the top face of PEM 13, and anode 17 is shown positioned along the bottom face of PEM 13; however, it is to be understood that the positions of cathode 15 and anode 17 relative to PEM 13 could be reversed.

Cathode 15 may consist of or may comprise a catalyst layer comprising the hybrid catalyst of the present invention and may be formed in the manner described above by being applied directly to PEM 13.

Anode 17, which may be a catalyst layer of the type conventionally used in a PEM-based fuel cell for the hydrogen oxidation reaction, may comprise electrocatalyst particles in the form of a finely divided electrically-conductive and, optionally, ionically-conductive material (e.g., a metal powder) which can sustain a high rate of electrochemical reaction. The electrocatalyst particles may be distributed within anode 17 along with a binder, which is preferably ionically-conductive, to provide mechanical fixation. Anode 17 may be formed in the conventional manner by being applied directly to PEM 13.

Although the catalyst coatings of the above-described MEA are applied directly to the proton exchange membrane, it is to be understood that the MEA of the present invention is not limited to such a construction. For example, in another embodiment, the respective catalyst coatings may be applied to suitable substrates, such as gas diffusion media (e.g., carbon paper), and two such coated substrates may then be positioned relative to the proton exchange membrane so that their catalyst coatings directly contact opposing surfaces of the proton exchange membrane. Then, the coated substrates may be fused to the proton exchange membrane by hot-pressing or another suitable technique. Such a membrane electrode assembly may be regarded as including a plurality of catalyst coated substrates.

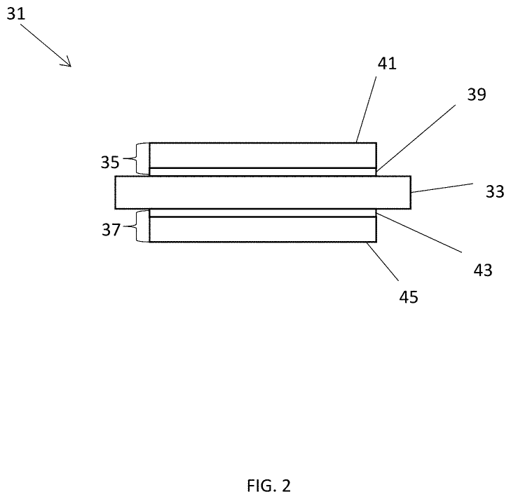

For example, referring now to FIG. 2, there is shown a simplified front view of one embodiment of a membrane electrode assembly constructed according to the present invention, the membrane electrode assembly being represented generally by reference numeral 31. (For simplicity and clarity, certain components of membrane electrode assembly 31 that are not critical to the understanding of the present invention are either not shown or described herein or are shown and/or described herein in a simplified manner.)

MEA 31 may comprise a PEM 33, which may be similar or identical to PEM 13 of MEA 11. MEA 31 may further comprise a cathode 35 and an anode 37. Cathode 35 and anode 37 may be positioned along two opposing major faces of PEM 33. In the present embodiment, cathode 35 is shown positioned along the top face of PEM 33, and anode 37 is shown positioned along the bottom face of PEM 33; however, it is to be understood that the positions of cathode 35 and anode 37 relative to PEM 33 could be reversed.

Cathode 35, in turn, may comprise a cathode electrocatalyst layer 39 and a cathode support 41. Cathode electrocatalyst layer 39, which may be similar or identical to cathode 15, may be positioned in direct contact with PEM 33, and, in the present embodiment, is shown as being positioned directly above and in contact with the top side of PEM 33.

Cathode support 41, which may be a cathode support of the type conventionally used in a PEM-based fuel cell, preferably comprises a material that is sufficiently porous to allow fluid (gas and/or liquid) transfer between cathode electrocatalyst layer 39 and some fluid conveying tube, cavity, or structure. In addition, cathode support 41 is preferably electrically-conductive to provide electrical connectivity between cathode electrocatalyst layer 39 and a cathode current collector or similar structure. Moreover, cathode support 41 is also preferably ionically-non-conductive. Cathode support 41 may be positioned in direct contact with cathode electrocatalyst layer 39 and, in the present embodiment, is shown as being positioned directly above cathode electrocatalyst layer 39 such that cathode electrocatalyst layer 39 may be sandwiched between and in contact with PEM 33 and cathode support 41. Cathode support 41 may be dimensioned to entirely cover a surface (e.g., the top surface) of cathode electrocatalyst layer 39, and, in fact, cathode 35 may be fabricated by depositing cathode electrocatalyst layer 39 on cathode support 41. Cathode 35 may then be coupled to PEM 33 by hot-pressing or another suitable technique.

Anode 37 may comprise an anode electrocatalyst layer 43 and an anode support 45. Anode electrocatalyst layer 43, which may be similar or identical to anode 17, may be positioned in direct contact with PEM 33, and, in the present embodiment, is shown as being positioned directly below and in contact with the bottom of PEM 33.

Anode support 45, which may be an anode support of the type conventionally used in a PEM-based fuel cell and may be, for example, a film or sheet of porous carbon, preferably comprises a material that is sufficiently porous to allow fluid (gas and/or liquid) transfer between anode electrocatalyst layer 43 and some fluid conveying tube, cavity, or structure. In addition, anode support 45 is electrically-conductive to provide electrical connectivity between anode electrocatalyst layer 43 and an anode current collector. Moreover, anode support 45 is also preferably ionically-non-conductive. Anode support 45 may be positioned in direct contact with anode electrocatalyst layer 43 and, in the present embodiment, is shown as being positioned directly below anode electrocatalyst layer 43 such that anode electrocatalyst layer 43 may be sandwiched between and in contact with PEM 33 and anode support 45. Anode support 45 may be dimensioned to entirely cover a surface (e.g., the top surface) of anode electrocatalyst layer 43, and, in fact, anode 37 may be fabricated by depositing anode electrocatalyst layer 43 on anode support 35. Anode 37 may then be coupled to PEM 33 by hot-pressing or another suitable technique.

The following examples are given for illustrative purposes only and are not meant to be a limitation on the invention described herein or on the claims appended hereto.

### EXAMPLE 1

### Catalyst Synthesis and Structure

The hybrid catalyst of the present invention may be made by various methods. For example, according to one embodiment, the Mn—N—C support may be made using an environmentally benign aqueous synthesis approach in which Mn-doped zeolitic imidazolate frameworks (ZIFs) are synthesized in water. This technique is disclosed, for example, in U.S. Patent Application Publication No. US 2022/0069315 A1 and in Chen et al., “Atomically Dispersed MnN4 Catalysts via Environmentally Benign Aqueous Synthesis for Oxygen Reduction: Mechanistic Understanding of Activity and Stability Improvements,” ACS Catalysts, 10(18):10523-10534 (2020), both of which are incorporated herein by reference. In the subsequent platinum nanoparticle deposition, an impregnation method with freeze-drying may be used to disperse the platinum nanoparticles on the Mn—N—C support. A forming gas (10 vol. % H₂ in argon) may be applied as a reductant to prepare the Pt/MnN₄—C catalyst. The foregoing method may be advantageous in that it may minimize the possible damage of MnN₄ sites by avoiding a complicated wet chemistry synthesis.

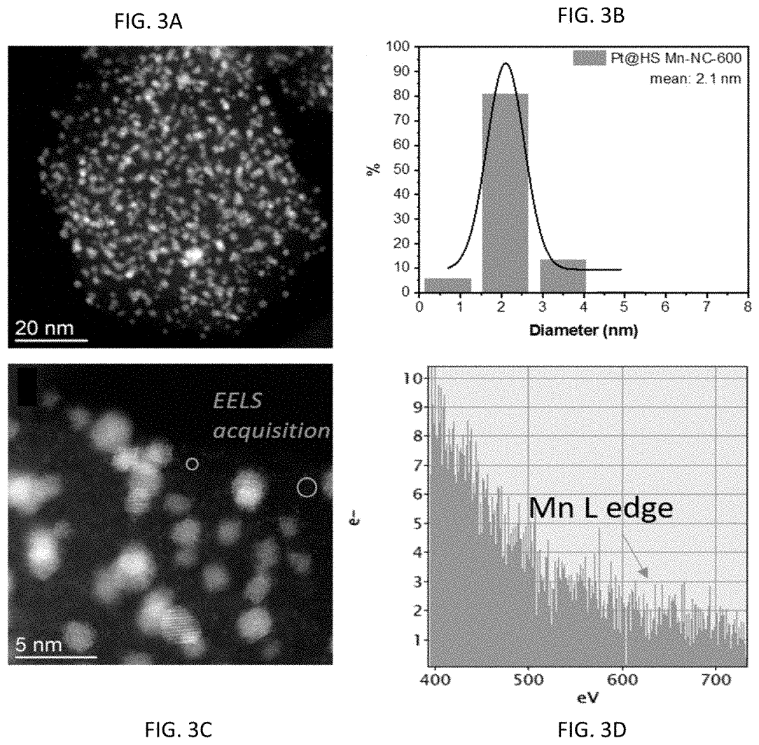

The morphology and composition of Pt@Mn—N—C-600, which was made as described above, were investigated by high-resolution transmission electron microscopy (HR-TEM). More specifically, referring to FIG. 3A, ultrafine platinum nanoparticles can be seen to be distributed evenly on a high surface area (HS) Mn—N—C support. Occasionally, the ultrafine platinum nanoparticles agglomerated into big particles with a size less than 5 nm. The size distribution of the platinum nanoparticles is summarized in FIG. 3B. The mean diameter of the platinum nanoparticles was found to be 2.1 nm with a narrow distribution. More detailed morphology of Pt@Mn—N—C-600 was revealed by using abbreviation-corrected HR-TEM (AC-HRTEM). More specifically, in FIG. 3C, ultrafine platinum nanoparticles with well-defined lattice fringes were found to anchor between atomically dispersed atoms. The single atoms circled in FIG. 3C were characterized by electron energy loss spectrum (EELS) and found to be manganese atoms (see FIG. 3D). The proximity of platinum nanoparticles to manganese single atoms may possibly induce synergistic oxygen reduction reaction (ORR) via tailoring of O₂ adsorption mode and electron configurations.

The motif of synergistic electrocatalysis between platinum and manganese single atom catalysts (SACs) was further verified by anchoring platinum on different kinds of Mn—N—C catalysts. For example, one alternative Mn—N—C catalyst, namely, Mn—SNC-1100, was prepared by an approach reported by Guo et al., “Promoting Atomically Dispersed MnN₄ Sites via Sulfur Doping for Oxygen Reduction: Unveiling Intrinsic Activity and Degradation in Fuel Cells,” ACS Nano, 15(4):6886-6899 (2021), which is incorporated herein by reference. In this catalyst, thiourea may be used as a precursor to dope an Mn—N—C matrix with sulfur. More specifically, in one embodiment, ZIF-8 may be subjected to a thermal activation at 900° C. under argon flow for 1 h in a tube furnace, with the heating rate being 30° C. min⁻¹. The product may be collected when the temperature cools down to room temperature, this product being denoted as NC. Thiourea (130 mg), and MnCl₂ (20 mg) may be dissolved in 2 mL solution (1 mL isopropanol, 1 mL 0.25 M HCl), followed by sonicating for 3 min, this solution being labeled as Solution A. Solution A may be added to a vial containing 20 mg of NC powder. Then, 0.2 mL of 2 M HCl solution may be added to the vial to avoid hydrolysis of MnCl₂. The mixture may be sonicated for 30 min below 18° C. and stirred for at least 1 h. Then, the precipitants may be collected by centrifugation without washing and then dried under a vacuum oven at 50° C. for 12 h. The dried precipitants may then be treated at 1100° C. for 1 h under argon flow, with the heating rate being 33° C. min⁻¹, the resulting product being Mn—SNC.

Another alternative Mn—N—C catalyst, namely, Mn—NC x3AC-1100, may be prepared by a solid synthesis strategy, in which MnO₂ may be employed as a manganese source, and an ammonium chloride (AC) post-treatment may be employed to further increase the density of manganese single atoms in the catalyst. More specifically, in one embodiment, 6.78 g Zn(NO)₂.6H₂O and 50 mg MnO₂ may be dispersed in 200 mL methanol in a round-bottom flask, followed by 20 min ultra-sonication. 2-methylimidazole (7.88 g) may be dissolved in another 200 mL methanol to form a Solution A. Solution A may be poured gradually into the round-bottom flask. The flask may be sealed with a rubber stopper along with a cable tie. The mixture may be transferred into a 60° C. oven. The oven may be kept at a constant temperature of 60° C. for 24 h. After cooling, the resulting suspension may be separated into four centrifuge tubes by centrifuging at 9000 rpm (10-15 mins each time) to collect all precipitant and washing with ethanol three times. 30 mL of ethanol for each tube may be used to wash the precipitant each time. The precipitant may be collected and dried at 60° C. in a vacuum oven for 12 h. The dried powder may then be finely ground to produce MnO₂-ZIF-8. 300 mg of the MnO₂-ZIF8 may be heated at 800° C. for 1 h. After heat treatment, the furnace may be cooled down to 25° C. in 30 minutes in program. Then, 100 mg of obtained carbon may be mixed with 300 mg NH₄Cl (x3AC) and heat-treated at 1100° C. for 1 h in a tube furnace under argon flow with a ramping rate of 35.8° C. min⁻¹. Then, the product may be allowed to cool down to room temperature naturally. Then, the obtained black powder may be ground and denoted as Mn—NC x3AC.

Yet another alternative Mn—N—C catalyst, namely, 125-0.12Mn—NC x4AC-1100, may be prepared using Mn-doped ZnO₂ nanoparticles, in which an ammonium chloride post-treatment may also be employed. For example, in one embodiment, 4.23 g Zn(NO)₂.6H₂O, 0.15 g MnCl₂, and 12.0 g sodium citrate may be dissolved in 180 mL deionized water under 60° C. Then, 4 g sodium hydroxide may be added and maintained for 1.5 h. After carefully washing and centrifuging, the as-prepared white powders may be vacuum-dried at 60° C. overnight and denoted as 0.15Mn—ZnO. 6.78 g Zn(NO)₂.6H₂O and 125 mg 0.15Mn—ZnO nanoparticles may be dispersed in 200 mL methanol in a round-bottom flask followed by 20 min ultra-sonication. 2-methylimidazole (7.88 g) may be dissolved in another 200 mL methanol and denoted as Solution A. Solution A may be gradually poured into the round-bottom flask. The flask may then be sealed with a rubber stopper along with a cable tie. The mixture may then be transferred into a 60° C. oven, the oven being kept at a constant temperature of 60° C. for 24 h. After cooling, the resulting suspension may be separated into four centrifuge tubes by centrifuging at 9000 rpm (10-15 mins each time) to collect all precipitant and washing with ethanol for three times. 30 mL of ethanol for each tube may be used to wash the precipitant each time. The precipitant may be collected and dried at 60° C. in a vacuum oven for 12 h. The dried powder may then be finely ground to produce 0.15MnZnO-ZIF-8. 300 mg of 0.15MnZnO-ZIF-8 may be heated at 800° C. for 1 h. After heat treatment, the furnace may be cooled down to 25° C. in 30 minutes in program. Then, 100 mg of obtained carbon may be mixed with 400 mg NH₄Cl (x4AC) and heat-treated at 1100° C. for 1 h in a tube furnace under argon flow with a ramping rate of 35.8° C. min⁻¹. The product may then be allowed to cool down to room temperature naturally. The obtained black powder may then be ground and denoted as 125-0.15Mn—NC x4AC.

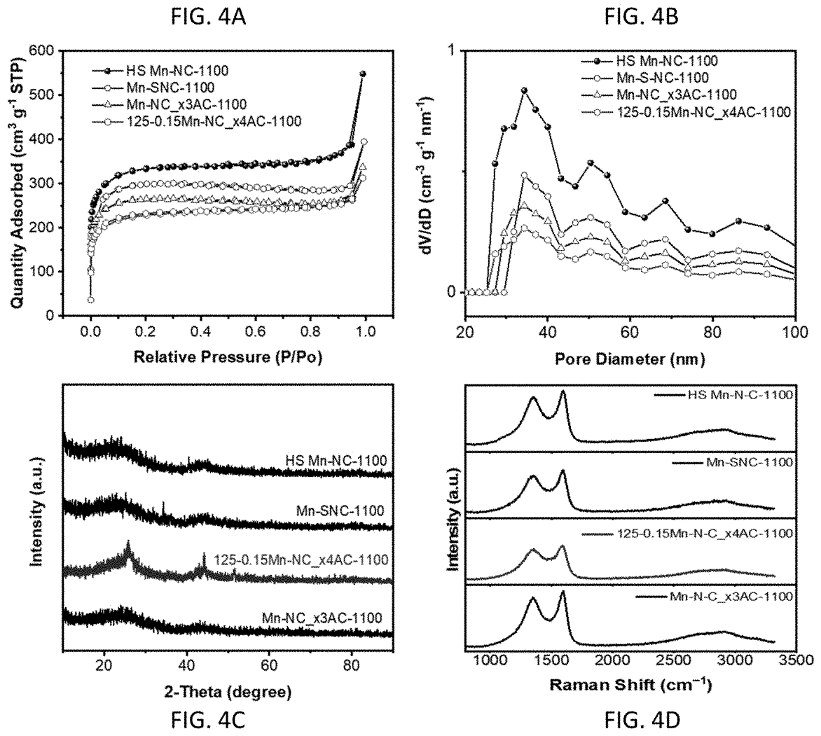

The porosity and microstructure of the aforementioned Mn—N—C catalysts were characterized by BET (Brunauer-Emmett-Teller), XRD (X-ray diffraction), and Raman spectra. In particular, referring to FIG. 4A, the BET surface areas for the catalysts appear in a stepwise manner, of which the BET surface areas were 1085.3 m² g⁻¹ for HS Mn—NC-1100, 953.6 m² g⁻¹ for Mn—SNC-1100, 858.1 m² g⁻¹ for Mn—NC-x3AC-1100, and 745.1 m² g⁻¹ for 125-0.15Mn—NC-x4AC-1100. No hysteresis loops were present. FIG. 4B shows porosity distributions in the prepared Mn—N—C catalysts, in which abundant mesopores were present. The mesopores arise from the stacking of catalyst particles, contributing to mass transport in a fuel cell. As can be seen, HS Mn—NC-1100 had the highest volume in the meso-porosity, which is crucial for mass transport in the application of fuel cells. In FIG. 4C, no diffraction peaks associating with Mn oxides appear in the XRD patterns of the prepared Mn—N—C catalysts, indicating the efficacy of the strategies in the preparations of atomically dispersed Mn catalysts. The graphitization degrees of Mn—N—C catalysts are characterized by Raman spectra in FIG. 4D, where the ratios of I_{D}/I_{G} are lower than 1.0, indicating that a high graphitization degree was achieved by introducing Mn in the ZIF-NC.

Platinum-cobalt (Pt—Co) intermetallic nanoparticle catalysts represent one of the most active oxygen reduction reaction catalysts known. In the experiments below, Pt—Co intermetallic nanoparticles were integrated with an active Mn—N—C support by using an impregnation method, followed by a reduction under forming gas at 350° C. Examples of Pt—Co intermetallic nanoparticles that were used include cubic L1₂ Pt₃Co intermetallic nanoparticles and tetragonal L1₀ PtCo intermetallic nanoparticles.

To prepare the L1₂ Pt₃Co intermetallic structures, a method for controlling their intermetallic structures was employed, said method involving annealing in a forming gas (10% H₂ in argon). It is believed that, by using the foregoing technique, the forming gas may enlarge the lattice spacing of platinum by changing the coordination environment of platinum, which allows the incorporation of more cobalt into the platinum lattice. Excess cobalt may behave as an obstacle to the formation of nanoparticle agglomerates during the annealing and can be easily removed using subsequent acid treatment. The foregoing method enables effective control of L1₂ Pt₃Co intermetallic structures on the Mn—N—C support, which allows a direct comparison of their catalytic activity, stability, and MEA (membrane electrode assembly) performance.

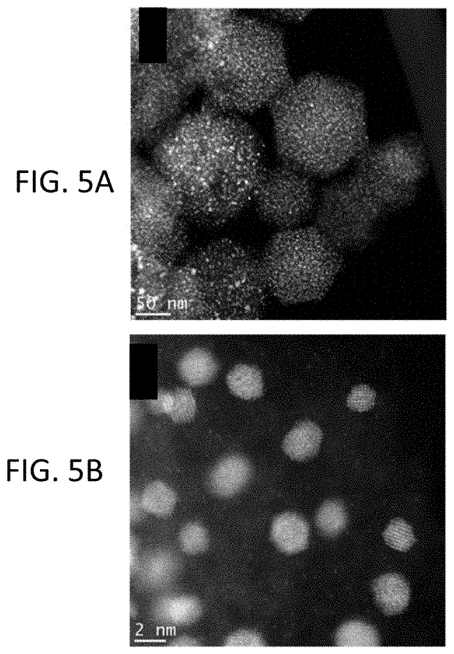

The morphology and structure of L1₂ Pt₃Co@HS Mn—NC-800 have been studied by high-resolution transmission electron microscopy (HR-TEM) imaging and diffraction techniques. In FIG. 5A, Pt₃Co nanoparticles can be seen to be uniformly dispersed on the surface of HS Mn—NC-1100. The mean size of the Pt₃Co nanoparticles was 3.0 nm, which is slightly larger than the Pt nanoparticles supported in HS Mn—NC-1100. Pt₃Co nanoparticles with a large size can be found in the prepared catalysts, but the ratio remains low. In FIG. 5B, ultrafine Pt₃Co nanoparticles anchored closely with atomically dispersed atoms. Electron energy loss spectra (EELS) revealed that these atoms were Mn. More detailed atomic structures of L1₂ Pt₃Co@HS Mn—NC-800 were studied with AC-HRTEM and selected area electron diffraction (SAED). The platinum and cobalt atoms were found to be arranged in a highly ordered way, and the pattern of SAED indicated that the platinum and cobalt atoms formed a L1₂ structure. The crystal structure was further studied using XRD (X-ray diffraction), and it was found that the diffraction peak of L1₂ Pt₃Co@HS Mn—NC-800 was positively shifted, as compared with Pt@HS Mn—NC-600. The introduction of cobalt into the platinum lattice yielded compression in the lattice. From XRD, two dominant phases in the L1₂ Pt₃Co@HS Mn—NC-800 were detected. It was found that platinum and cobalt formed a uniform distribution in the nanoparticles whereas manganese tended to enrich near the PtCo nanoparticles. This tendency enhances the synergistic effect between Pt₃Co and a Mn-based catalyst support.

To prepare tetragonal L1₀ PtCo intermetallic structures, PtCo nanoparticles may be deposited onto HS (high surface area) Mn—N—C-1100 through a forming gas (hydrogen (10%)+argon) reduction method, for example, with a controlled platinum mass loading of 20 wt. %. More specifically, in one example, 2.505 mL hexachloroplatinic acid solution (10 mg/mL) was dropped into a vial containing 37.0 mg HS Mn—N—C-1100 and 27.5 mg CoCl2.6H₂O. The mixture was sonicated in an ice bath for 1 hour to form a homogeneous complex suspension. The suspension was quickly frozen with liquid nitrogen, followed by freeze-drying overnight. The dried powder was then heated at 350° C. in a tube furnace under forming gas flow for 2 h. After cooling down to 25° C., the furnace was reheated to 750° C. for another 3 hours under forming gas to prepare ordered L1₀ PtCo intermetallic structures. The resulting powder was leached by 0.1M HClO₄ at 60° C. for 6 hours and post-treated at 400° C. under argon to obtain the final catalyst.

Alternatively, the cubic crystal structure of L1₂ Pt₃Co can be transformed into the tetragonal crystal structure of L1₀ PtCo by further adding cobalt in the formation of intermetallics.

### EXAMPLE 2

### Electrocatalysis Study for Oxygen Reduction Reaction (ORR) in Aqueous Acidic Electrolytes

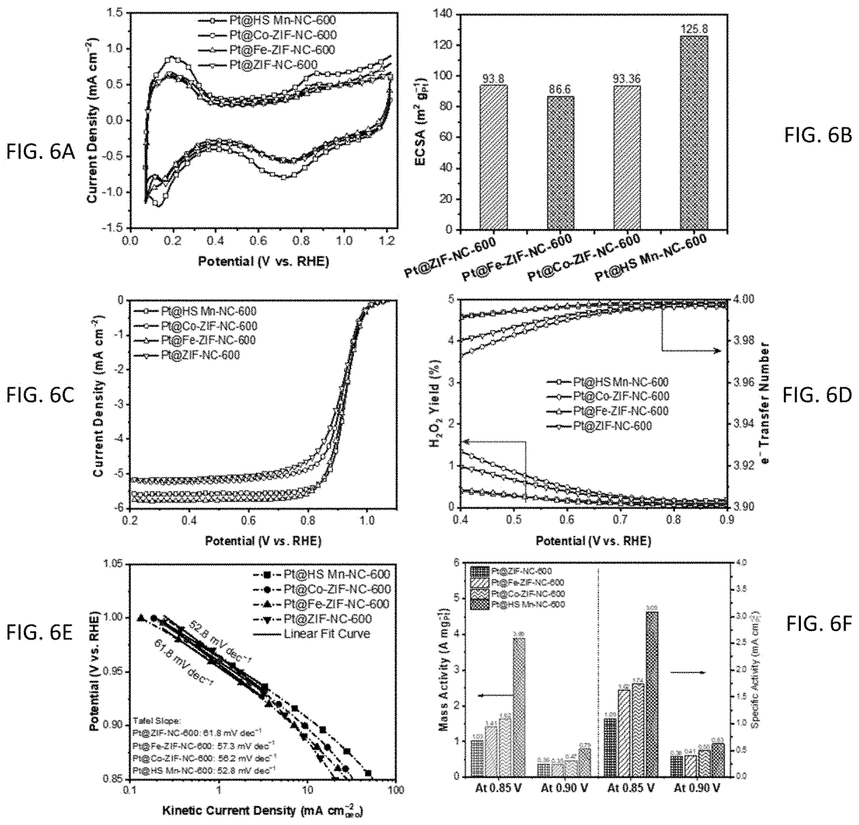

In order to identify the promise of an Mn—N—C catalyst as a supporting material for a Pt-based catalyst, identical synthesis methods were used to produce corresponding Co-based and Ni-based supports, and the oxygen reduction reaction (ORR) catalytic performances for the various catalysts were studied and compared. In FIGS. 6A and 6B, high electrochemically active surface areas (ECSAs) were achieved by using ZIFs-derived nanocarbon as supports. The ECSAs ranged from 86.6 m² g_{Pt}⁻¹ to 125.8 m² g_{Pt}⁻¹. It is noteworthy that platinum nanoparticles supported on high surface area Mn—N—C (HS Mn—NC) achieved the highest ECSA, namely, a value of 125.8 m² g_{Pt}⁻¹. The HS Mn—N—C with a Brunauer-Emmett-Teller (BET) surface area of 1085.3 m² g_{Pt}⁻¹ was prepared using the environmentally benign aqueous synthesis technique identified above. The oxygen reduction reaction (ORR) performance of the platinum catalysts was evaluated using the rotating ring-disk electrode (RRDE) test.

In FIG. 6C, it can be seen that platinum supported on M—N—C (M═Ni, Co, Mn) showed enhanced oxygen reduction reaction performance as compared to ZIF-NC. Although Pt@Co—NC-600 and Pt@ZIF-NC-600 have a closing electrochemically active surface area (ECSA), an enhanced oxygen reduction reaction activity was obtained by Pt@Co—NC-600. For Pt@Ni—NC-600, even though its ECSA is lower than its counterparts, a significantly enhanced oxygen reduction reaction activity was achieved. A possible synergistic effect between platinum and M—N—C may contribute to the enhancement in oxygen reduction reaction activity observed. In FIG. 6D, the selectivity of the prepared platinum catalysts towards the oxygen reduction reaction was quantified by in-situ monitoring of H₂O₂ yield at different potentials. More specifically, at a potential of >0.6 V_{RHE}, the H₂O₂ yield retained <1.0% for the prepared catalysts. However, with a lower potential, the H₂O₂ yield in Pt@Co—NC-600 increased, indicating a transition of O₂ adsorption mode on a Co—N—C support. It is hypothesized that an end-on adsorption mode on Co—N—C may be preferred for O₂ in high overpotential. To eliminate the difference in the mass transport in the thin film electrode for ring-disk electrode (RRDE) tests, kinetic current densities were obtained by Koutecky-Levich equations. The kinetic current densities at different potentials were translated into Tafel plots in FIG. 6E. More specifically, as can be seen in FIG. 6E, Pt@M—NC-600 presents a lower Tafel slope (i.e., 52.8 mV dec⁻¹ to 57.3 mV dec⁻¹), highlighting that a non-conventional oxygen reduction reaction process takes place in the atomically dispersed M—N—C supported Pt catalysts. The Tafel slope of Pt@ZIF-NC-600 shows a value of 61.8 mV dec⁻¹, which is close to the slopes of Pt/C that have been frequently reported in the literature. The classic Tafel slope of Pt@ZIF-NC-600 indicates that only platinum functions as an active component during the electrocatalytic process. The differences in the oxygen reduction reaction activities are further compared by taking the platinum loading and electrochemically active surface areas (ECSAs) into consideration. In FIG. 6F, Pt@Mn—NC-600 shows both highest mass activity (MA) and specific activity (SA) at 0.85 V_{RHE} and 0.90 V_{RHE}. The specific activity (SA) of Pt@Mn—NC-600 is as high as 0.63 mA cm_{Pt}⁻², indicating that a synergistic effect between Mn—N—C and Pt contributes to the oxygen reduction reaction.

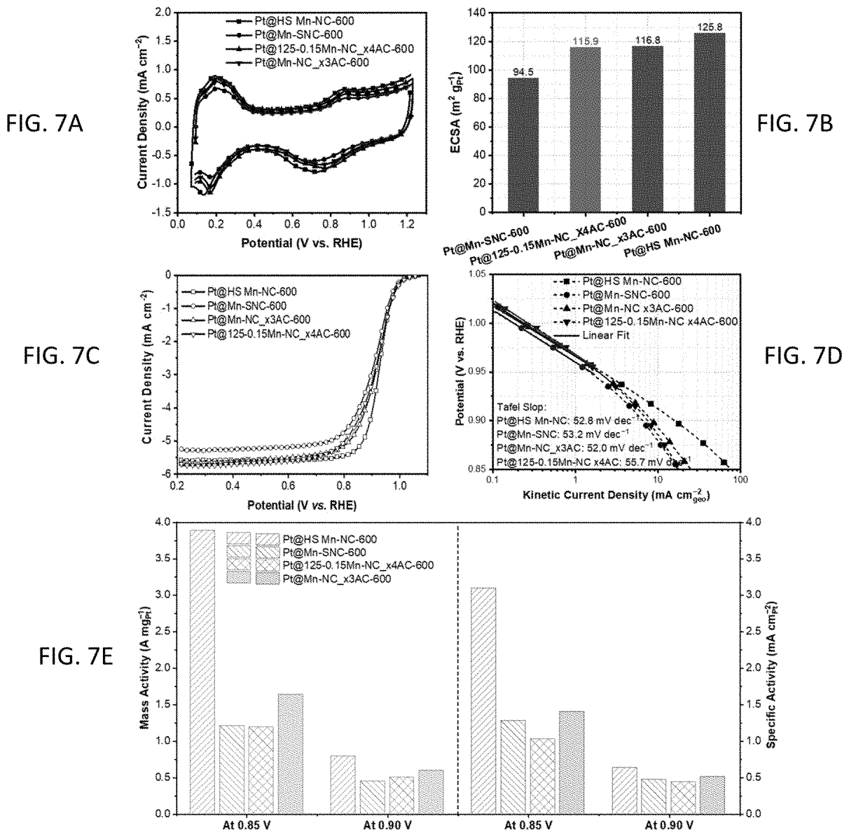

Next, platinum catalysts were prepared using Mn—N—Cs as supports. In FIGS. 7A and 7B, the platinum catalysts supported on Mn—N—C show high electrochemically active surface areas (ECSAs). The oxygen reduction reaction (ORR) performance of the Pt@Mn—NC catalysts was assessed in ring-disk electrode (RRDE) tests. In FIG. 7C, Pt@Mn—SNC-600 shows slightly lower performance. A lower ECSA of Pt@Mn—SNC-600 may limit its performance. To deduct the effect of mass transport, Tafel plots were obtained from Koutecky-Levich equations. In FIG. 7D, the Tafel slopes for Pt@Mn—NCs are lower than 60 mV dec⁻¹, indicating that the synergistic effect between platinum and the Mn—N—C support is universal. The oxygen reduction reaction (ORR) activities of the Pt@ Pt@Mn—N—Cs are normalized to mass and specific area. In FIG. 7E, Pt@HS Mn—NC-600 has the highest mass activities (MAs) at both 0.85 V_{RHE} and 0.90 V_{RHE}, demonstrating a high utilization of platinum. The high utilization of platinum may be ascribed to the abundant meso-porosity in the HS Mn—NC-1100, which facilities the diffusion of O₂ in the thin film catalyst layer. For platinum catalysts supported on Mn—N—C with similar meso-porosity volume, the mass activities (MAs) and specific activities (SAs) were maintained at a similar level.

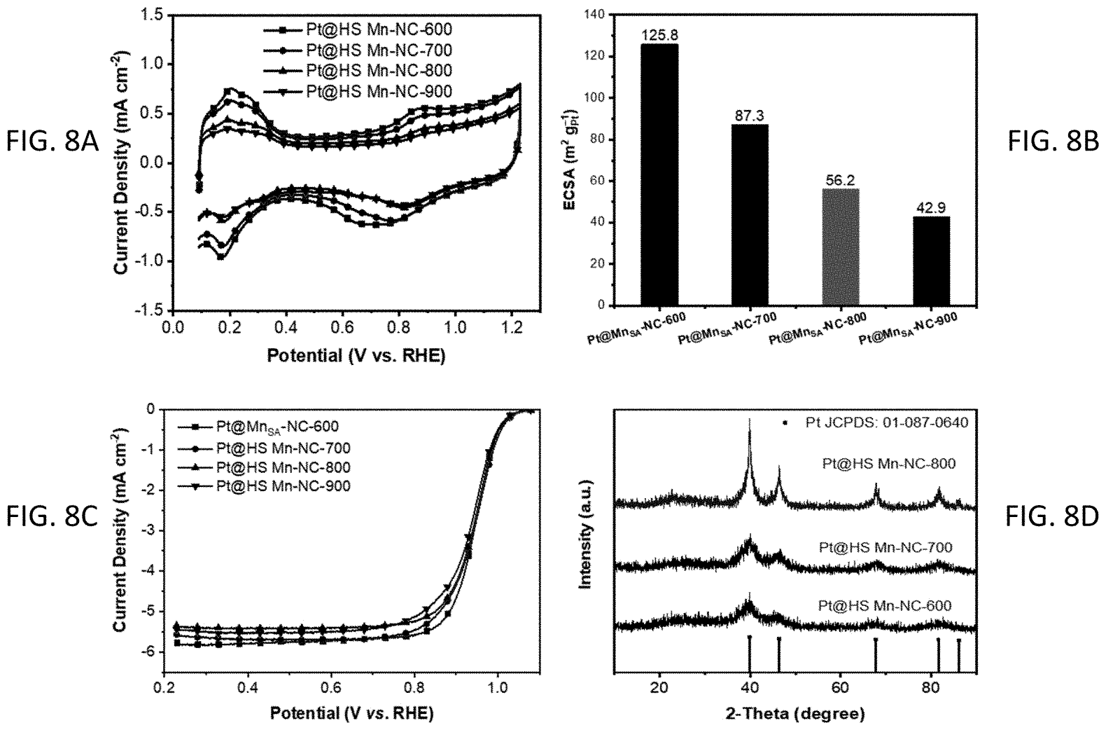

The impact of thermal annealing on the oxygen reduction reaction performance was investigated by using high surface area (HS) Mn—NC-1100 as a support. In FIGS. 8A and 8B, the electrochemically active surface areas (ECSAs) of Pt@ HS Mn—NC dropped with an increase in the annealing temperature, but the value still remained high at 800° C. However, in FIG. 8C, the variation in oxygen reduction (ORR) activity was insignificant compared with the change in electrochemically active surface area (ECSA). In FIG. 8D, at a higher annealing temperature, a higher crystallization degree occurred, leading to a decrease in ECSA.

### EXAMPLE 3

### MEA Tests in Fuel Cell

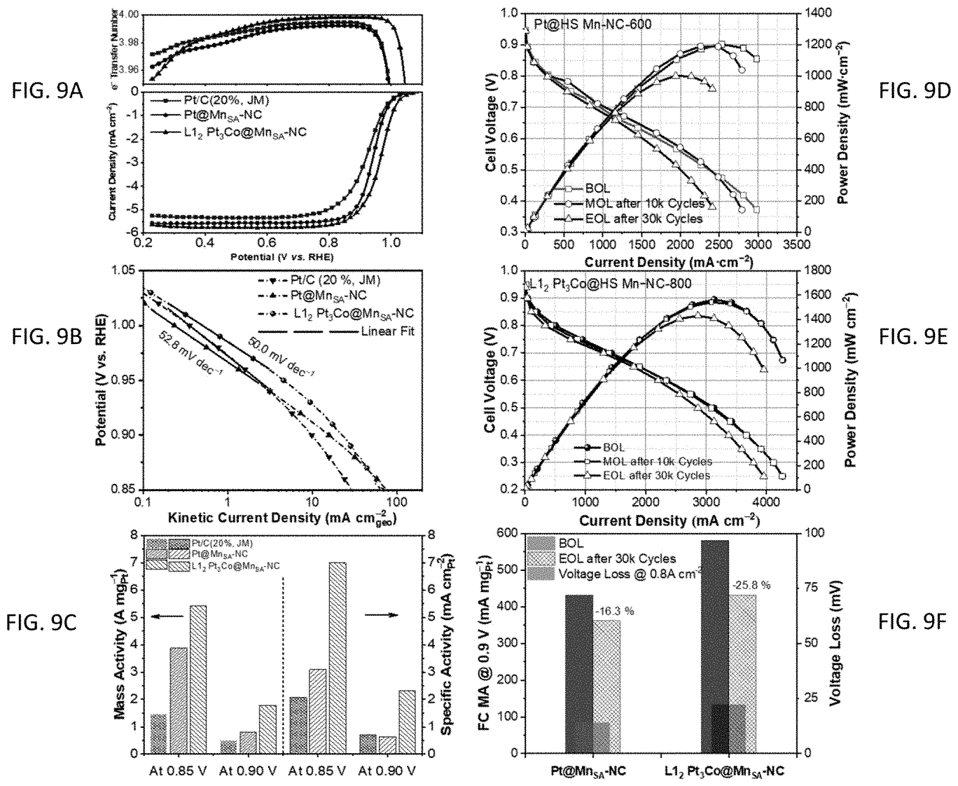

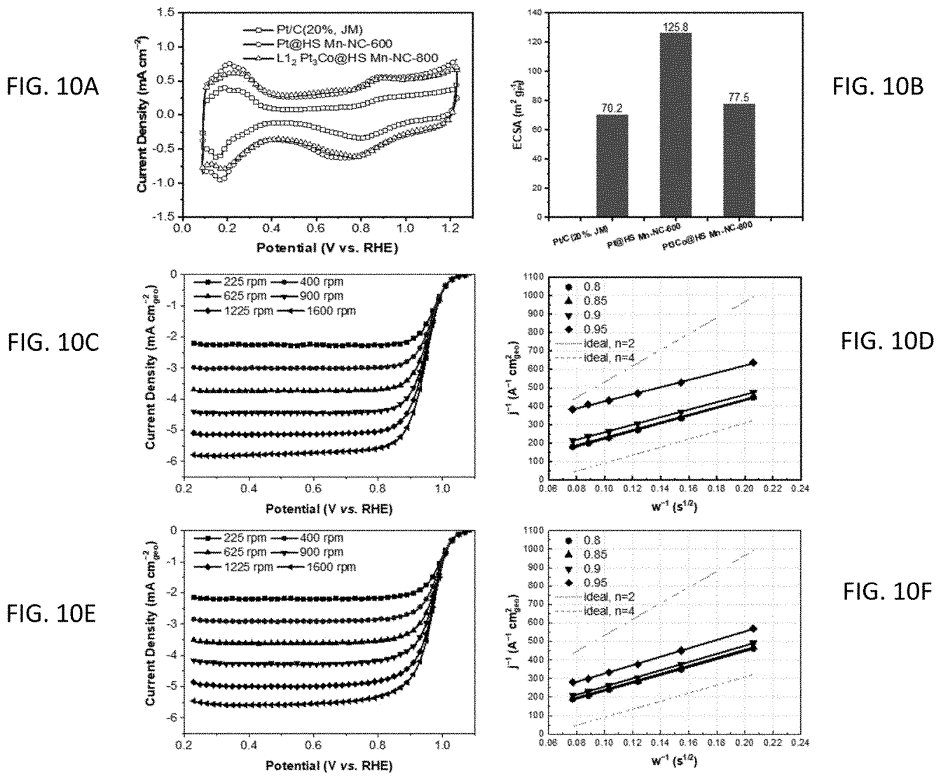

To increase the activity and stability of a hybrid platinum/Mn—N—C catalyst of the present invention, cobalt was introduced into the synthesis of the catalyst nanoparticles. For example, in one case, L1₂ Pt₃Co intermetallics were synthesized. A high annealing temperature was employed to promote the formation of Pt₃Co intermetallics, instead of a random Pt₃Co alloy. As can be seen in FIG. 9A, a significant increase in onset and half wave potential (E_{1/2}) was achieved with L1₂ Pt₃Co@HS Mn—NC-800. The electrochemically active surface areas (ECSAs) of the catalysts were evaluated by electrochemical oxidation of a monolayer of hydrogen atoms adsorbed onto platinum. As can be seen in FIGS. 10A and 10B, although a high temperature was applied during the synthesis of L1₂ Pt₃Co@HS Mn—NC-800, its ECSA (77.5 m² g_{Pt}⁻¹) was still higher than a commercial Pt/C catalyst (70.2 m² g_{Pt}⁻¹), manifesting the advantages of high surface area (HS) Mn—N—C in suppressing the agglomeration of platinum nanoparticles. As compared to pure platinum catalysts, a nearly whole 4e⁻ process occurs during the oxygen reduction reaction (ORR). The electron transfer numbers were further confirmed by analyzing Koutechy-Levich plots at different rotating speeds (FIGS. 10C and 10E). In FIGS. 10D and 10F, both L1₂ Pt₃Co and platinum supported on HS Mn—NC-1100 exhibited an ideal 4e⁻ transfer process in the potential range of 0.8 V_{RHE} to 0.95 V_{RHE}. The oxygen reduction reaction (ORR) activity of L1₂ Pt₃Co@HS Mn—NC-800 was compared to that of Pt@HS Mn—NC-600 using Koutecky-Levich equations to obtain pure kinetic current density. As can be seen in FIG. 9B, L1₂ Pt₃Co@HS Mn—NC-800 showed a higher kinetic rate, especially at a potential above 0.9 V_{RHE}. L1₂ Pt₃Co@HS Mn—NC-800 presented the lowest Tafel slope, with a value of 50.0 mV dec⁻¹. The low Tafel slope indicates that the activation energy for the oxygen reduction reaction was significantly reduced in L1₂ Pt₃Co@HS Mn—NC-800. The mass activity (MA) and specific activity (SA) at 0.85 V_{RHE} and 0.90 V_{RHE} were compared and are summarized in FIG. 9C. As can be seen in FIG. 9C, L1₂ Pt₃Co@HS Mn—NC-800 presented the highest mass activity and specific activity compared to its counterparts. Consequently, it can be inferred that the formation of L1₂ Pt₃Co can effectively enhance oxygen reduction reaction activity.

In addition to activity, durability is another important criterion for platinum-based catalysts to be used in proton-exchange membrane fuel cells (PEMFCs). The activity and durability of L1₂ Pt₃Co@HS Mn—NC-800 and Pt@HS Mn—NC-600 were further investigated in a single cell test. As can be seen in FIGS. 9D and 9E, both Pt@HS Mn—NC-600 and L1₂ Pt₃Co@HS Mn—NC-800 achieved high performance, the high performance maintaining well even after 30,000 accelerated durability test (ADT) cycles in a fuel cell. The mass activity of Pt@HS Mn—NC-600 in a fuel cell was 0.43 A mg_{Pt}⁻¹ (@0.9V_{iR-free}), approaching that of the Department of Energy (DOE) target for the year 2025. For L1₂ Pt₃Co@HS Mn—NC-800, the mass activity @0.9V_{iR-free} was 0.58 A mg_{Pt}⁻¹, exceeding that of the DOE 2025 target. The mass activity maintained well after 30,000 ADT cycles in a fuel cell. For Pt@HS Mn—NC-600, the mass activity (MA) loss was 16.3%, and for L1₂ Pt₃Co@HS Mn—NC-800, the mass activity loss was 25.8% (FIG. 9F).

In practical applications, the current density above 0.67 V is more meaningful. For Pt@HS Mn—NC-600, the current density was 1.16 A cm⁻² whereas for L1₂ Pt₃Co@HS Mn—NC-800, the current density increased to 1.69 A cm⁻². The voltage losses at 0.8 A cm⁻² were 14 and 22 mV for Pt@HS Mn—NC-600 and L1₂ Pt₃Co@HS Mn—NC-800, respectively. The high activity and durability of both Pt and L1₂ P₃Co supported on HS MN—NC are very desirable.

The aged L1₂ Pt₃Co@HS Mn—NC-800 was investigated with high-resolution transmission electron microscopy (HR-TEM) and energy-dispersive x-ray spectra (EDS). It was found that the particle size of L1₂ Pt₃Co@HS Mn—NC-800 increased after intensive accelerated durability test (ADT) cycling. The ultrafine Pt₃Co nanoparticles agglomerated, leading to a sparse distribution of platinum-based nanoparticles on the Mn—N—C support. In one case, two Pt₃Co nanoparticles merged into one, with a partial retention of ordered structure. Electron energy loss spectra (EELS) indicated that Mn atoms were still atomically dispersed in the N-doped carbon matrix. In addition, there is a heterogeneous distribution of PtCo particles on the Mn—N—C support. Energy-dispersive X-ray spectra (EDS) mapping indicated that cobalt leached away during accelerated stress test (AST) cycles, with the atomic ratio of platinum to cobalt increasing to 92.55:7.45.

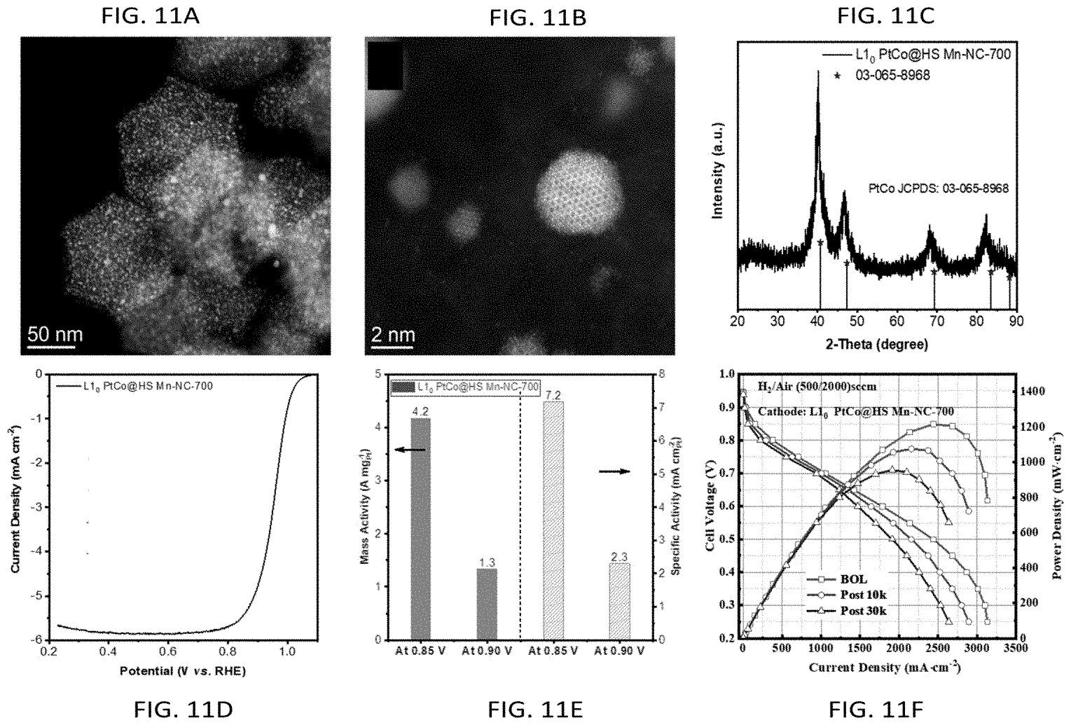

As noted above, the cubic crystal structure of L1₂ Pt₃Co can be transformed into tetragonal crystals by further adding cobalt during the formation of intermetallics. As shown in FIG. 11A, the addition of cobalt did not induce agglomeration of PtCo nanoparticles. Platinum and cobalt atoms formed a highly ordered arrangement in the nanoparticle (FIG. 11B). The crystal structure of the prepared catalyst was revealed by XRD (X-ray diffraction), as shown in FIG. 11C. The diffraction pattern of the prepared catalyst can be indexed as PtCo (JCPDS: 03-065-8968). The electrocatalytic performance of L1₀ PtCo supported on HS Mn—N—C was investigated in both RRDE (rotating ring-disk electrode) and single cell. As can be seen from FIG. 11D, the electrochemically active surface area (ECSA) of L1₀ PtCo@HS Mn—NC-700 was 58.1 m² g⁻¹_{Pt}, which was lower than that for Pt@HS Mn—NC-600 and L1₂ Pt₃Co@HS Mn—NC-800. The extra cobalt underneath the platinum skin decreased the adsorption of the hydrogen monolayer, leading to a decreased ECSA. Although the ECSA of L1₀ PtCo@HS Mn—NC-700 deceased, the intrinsic activity is still promising. The MA (mass activity) and SA (specific activity) of L1₀ PtCo@HS Mn—NC-700 derived from linear scanning voltammetry (FIG. 11D) is summarized in FIG. 11E. From FIG. 11E, the mass activity (@0.9 V) was 1.3 A m g⁻¹_{Pt}, which falls between that for Pt@HS Mn—NC-600 (1.2 A m g⁻¹_{Pt}) and L1₂ Pt₃Co@HS Mn—NC-800 (1.8 A m g⁻¹_{Pt}). The compromised intrinsic activity may be attributed to the increased oxyphilicity in the PtCo catalyst by introducing extra cobalt. The strong bonding of oxygenated species on the platinum skin decreased the turnover frequency. The activity and durability of L1₀ PtCo@HS Mn—NC-700 were further studied in a single cell. As shown in FIG. 11F, the initial performance of L1₀ PtCo@HS Mn—NC-700 increased as compared to Pt@HS Mn—NC-600; nonetheless, it was still lower than L1₂ Pt₃Co@HS Mn—NC-800. The tendency was within good accordance with RRDE (rotating ring-disk electrode) performance, highlighting the good translation of RRDE performance into single cell performance. After 30,000 accelerated durability test cycles, the voltage loss below the current density of 1 A cm⁻² was minimum. The minimum voltage loss in activating region indicates that the stability of L1₀ PtCo@HS Mn—NC-700 is promising. However, the peak power density decreased notably. The huge loss in peak power density may be related to the cobalt leaching in the catalyst layer, as the platinum skins coated on the overlayer of L1₀ PtCo nanoparticles are thin. Cobalt can be dealloyed by intensive potential cycling under harsh test conditions (high temperature, low pH, and intense potential cycling). The leached cobalt will contaminate the ionomer, leading to a decreased proton conductivity and decreased O₂ solubility.

### EXAMPLE 4

### High-Platinum-Content Catalysts on Atomically Dispersed and Nitrogen Coordinated Single Manganese Site Carbons for Heavy-Duty Fuel Cells

Recently, driven by the distinct scalability of fuel cells concerning energy and power, more significant attention regarding fuel cell applications has been transferred from light-duty vehicles (LDVs) to heavy-duty vehicles (HDVs). (Heavy-duty vehicles may be regarded as vehicles having a weight above a certain threshold, such as 26,001 pounds.) In heavy-duty vehicles, the dimension of the fuel cell stack or hydrogen tank can be increased with a small additional weight/volume penalty. Moreover, fewer hydrogen stations are needed because of predesigned routes for heavy-duty vehicles, resulting in less infrastructure investment. Additionally, given the high loading of precious metal used in current diesel trucks, the shift to heavy-duty vehicles allows for platinum loadings as high as around 0.3 mg cm⁻² without a significant increase in cost. However, durability issues associated with heavy-duty vehicles are more challenging because they require an extended lifespan (more than 25,000 hours), as compared to light-duty vehicles (around 5,000 hours). Moreover, higher operating voltages and temperatures for high efficiency and much longer lifespan tend to accelerate cell degradation. Therefore, new materials (membranes, ionomers, and catalysts) are needed to meet the challenging efficiency and durability requirements posed by heavy-duty vehicles.

The loss of catalyst performance in membrane electrode assemblies (MEAs) significantly contributes to the durability issue. For example, power density loss mainly results from the loss of catalytic electrochemical surface area (ECSA), which is a consequence of platinum nanoparticle agglomeration and dissolution. The carbon support plays a vital role in achieving fine platinum nanoparticle (NP) dispersion, compatibility with an ionomer, sufficient ECSA, and strengthened Pt-carbon interaction, directly governing performance and durability. In addition, oxygen transport, the reaction kinetics of oxygen reduction reaction (ORR), and ECSA can be well-controlled by tuning the pore structure of carbon supports. Generally, the carbon supports can be divided into three main categories: (i) high surface area and relatively amorphous mesoporous carbon; (ii) highly graphitized but less porous carbon; (iii) carbon supports that combine the advantages of the above two kinds of carbons, together with the trade-off of the graphitic structure and porosity. Typically, a high-surface-area carbon support improves the mass activity and accessibility to reactants of platinum nanoparticles. However, it generally contains dominant defects and amorphous structures, which are prone to oxidization. In contrast, a high degree of graphitization can reduce carbon oxidation and improve durability, but is less favorable for improving platinum nanoparticle dispersion and strengthening platinum-carbon interactions.

Besides controlling the size and dispersion of platinum nanoparticles, the intrinsic activity of a platinum catalyst can be improved by preparing the PtM (wherein M is a transition metal) alloy nanostructure. However, transition metals are typically leached out during fuel cell operation, resulting in a loss of benefit of introducing the transition metals into platinum. Even worse, the leached transition metals can contaminate the membrane and ionomer, which mitigates proton and oxygen transports.

Compared to traditional 20 wt. % Pt/C catalysts, a high platinum content on carbon support (e.g., 40 wt. %) is more desirable for heavy-duty membrane electrode assemblies (MEAs) because the higher platinum loading in a heavy-duty MEA cathode (0.2 mg_{Pt}/cm²) causes thick cathode layers and significantly increases the mass transfer resistance. Thus, high platinum content on carbon support is more suitable for heavy-duty MEAs, which can achieve high platinum loadings without a mass transport penalty. Therefore, in this example, two platinum catalysts were fabricated with a high platinum loading content (40 wt. %). One such catalyst is a highly graphitized porous graphitic carbon (PGC) with a relatively lower porosity than a commercially available high-surface-area TKK carbon (Tanaka Holdings Co., Ltd., Tokyo, Japan). The other is a platinum group metal (PGM)-free carbon catalyst derived from Mn-doped ZIFs, containing atomically dispersed and nitrogen coordinated single Mn sites embedded in a high-surface-area and partially graphitic carbon structure (Mn—N—C). Both supports were doped with N dopants, resulting in a basic property and enhanced π-bonding, due to the nature of nitrogen as an electron donor, which plays an essential role in anchoring platinum nanoparticles firmly and mitigating platinum nanoparticle migration. Importantly, the atomically dispersed single metal site (e.g., FeN₄ or CoN₄) could generate a synergy to boost the oxygen reduction reaction (ORR) activity of platinum catalysts. As will be discussed below, a comparison of the foregoing platinum catalysts to a commercial TKK 40 wt. % Pt/C (TEC10E40E) catalyst (Tanaka Holdings Co., Ltd., Tokyo, Japan) reveals that the Mn—N—C carbon is more advantageous than the aforementioned TKK Pt/C catalyst for at least the reason that it is more capable of significantly promoting catalytic activity and stability of platinum nanoparticles in both aqueous acids and MEAs. Extensive characterization further elucidates that the Mn—N—C carbon support provides much-strengthened interaction between platinum nanoparticles and the carbon support, therefore mitigating possible platinum nanoparticle agglomeration or de-attachment under heavy-duty fuel cell operating conditions.

Catalyst synthesis: The synthesis procedure for the Mn—N—C support is based on the procedure discussed above, as well as that disclosed in Chen et al., “Atomically Dispersed MnN₄ Catalysts via Environmentally Benign Aqueous Synthesis for Oxygen Reduction: Mechanistic Understanding of Activity and Stability Improvements,” ACS Catalysis, 10:10523-10534 (2020), which is incorporated herein by reference. The synthesis for the PGC support is based on the procedure disclosed in Qiao et al., “3D porous graphitic nanocarbon for enhancing the performance and durability of Pt catalysts: a balance between graphitization and hierarchical porosity, Energy & Environmental Science, 12:2830-2841 (2019), which is incorporated herein by reference.

The platinum nanoparticle deposition may be carried out using a modified ethylene glycol (EG) reduction method with a controllable platinum mass content of 40 wt. %. More specifically, in one embodiment, the carbon support (e.g., 40 mg) may be dispersed in an EG/H₂O (1:1) solution (e.g., 160 ml) first, followed by sonicating for one hour to form a homogeneous suspension. Then, a certain amount of chloroplatinic acid solution may be added to the suspension under sonicating for 30 minutes purged with N₂. The carbon suspension containing platinum sources may be refluxed at 130° C. for four hours under continuous purging with N₂ bubbling. The resulting catalysts may be filtered with Millipore water and dried at 60° C. in a vacuum oven for 24 hours. Finally, the resultant catalyst may be post-treated at 800° C. under argon for one hour.

Physical characterization: X-ray diffraction (XRD) pattern was performed on a Rigaku Ultima IV diffractometer (Rigaku Corporation, Tokyo, Japan) with Cu Kα X-rays to study crystal phases in each sample. Raman spectroscopy was performed using a Renishaw Raman system (Renishaw, Inc., West Dundee, Ill.) at 514 nm excitation. Samples were prepared as ink on a standard microscope glass slide, with the excitation laser focused through a 50× microscope objective for a total interrogation spot size of 1.0-micron diameter. X-ray photoelectron spectroscopy (XPS) was performed using a Kratos AXIS Ultra DLD XPS system (Kratos Analytical Limited, Manchester, UK) equipped with a hemispherical energy analyzer and a monochromatic Al Kα source. The monochromatic Al Kα source was operated at 15 keV, and 150 W. Pass energy was fixed at 40 eV for the high-resolution scans. All samples were prepared as pressed powders supported on a metal bar for the XPS measurements. Transmission electron microscope (TEM) images were obtained on a Thermo-Fisher Talos F200X transmission electron microscope (Thermo Fischer Scientific, Waltham, Mass.). Secondary electron and medium-angle annular dark-field-scanning TEM (MAADF-STEM) images were acquired with a Hitachi HD2700C dedicated STEM (Hitachi High-Tech America, Inc., Schaumburg, Ill.) with a probe Cs corrector. Both microscopes were operated at an accelerating voltage of 200 kV.

Electrochemical measurements: All electrochemical measurements were conducted using a CHI electrochemical workstation (CHI760b) coupled with a rotating-ring disk electrode (RRDE) in a three-electrode system. A graphite rod and a Hg/Hg₂SO₄ (K₂SO₄-sat.) electrode were used as the counter and reference electrodes, respectively. A glassy carbon disk covered by a thin film of the catalyst was used as the working electrode. Each catalyst powder (5 mg) was ultrasonically dispersed in a 1.0 mL mixture of isopropanol and NAFION® sulfonated tetrafluoroethylene based fluoropolymer-copolymer (5 wt. %) solution to produce a catalyst ink. The ink was then drop-casted on the rotating ring disk electrode with a mass loading of 20 μg_{Pt}/cm². The catalyst-coated disk working electrode was subjected to cyclic voltammetry (CV) in N₂-saturated 0.1 M HClO₄ to activate the platinum catalysts being studied. The electrochemically active surface area (ECSA) calculation was based on underpotentially-deposited hydrogen (HUPD) charge in cyclic voltammetry (CV) curves (20 mV s⁻¹) in an N₂-saturated electrolyte between 0.1-0.4 V (0.4-0.45 V background subtracted), assuming a value of 210 μC/cm² for the adsorption of a hydrogen monolayer on platinum. The electrocatalytic activity for the oxygen reduction reaction was tested by a linear sweep voltammetry (LSV) technique at room temperature, a rotation rate of 1600 rpm, and a scan rate of 5 mV/s. The stability of the catalyst was studied by potential cycling from 0.6 V to 0.95 V in 0.1 M HClO₄ electrolyte at a scan rate of 50 mV/s at room temperature.

Fuel cell MEA studies: All electrodes were fabricated using the catalyst-coated membrane (CCM) method. First, the anode electrode was fabricated using a Pt/Vulcan catalyst. The catalyst ink was prepared by mixing platinum catalysts with ionomer using deionized water (DI-water) and 1-propanol (nPA) in a bath sonicator for 30 min. Then, a Sono-Tek spray machine (Sono-Tek Corporation, Milton, N.Y.) was used to coat the anode layer with a loading of 0.1 mg_{Pt}/cm² on a proton exchange membrane (Gore MX20.15, W. L. Gore & Associates, Inc., Newark, Del.). Various cathode electrodes were prepared using 40 wt. % Pt/C catalysts, including homemade Pt/Mn—N—C and Pt/PGC catalysts, as well as a TKK Pt/C catalyst. The same spray coating was applied to fabricate cathode layers with a loading of 0.2 mg_{Pt}/cm² on the opposite side of the membrane coated with the anode electrode. Finally, the resulting MEAs were tested using a 5 cm² differential cell at 80° C. and under constant flow rates: 500 standard cubic centimeters per minute (sccm) H₂ for the anode and 2000 sccm air for the cathode. The applied backpressure was 250 kPa, following the protocol for HDV MEAs. During the fuel cell MEA tests, US DOE fuel cell testing protocols were followed by holding constant voltages from 0.35 V to open-circuit voltage (OCV) at 50 mV/step and 60 seconds hold per step. Before the polarization test, 16 hr break-in was required. The break-in protocol was to scan voltage between 0.7 V and 0.35 V, 50 mV/ step and 5 min hold per step. Fuel cell MEA stability was evaluated based on the voltage cycling accelerated stability test (AST) suggested by the U.S. DOE, which was conducted using the trapezoidal wave method from 0.6 V to 0.95 V with 0.5 s rise time and 2.5 s hold time (150 kPa, H₂/N₂, 80° C., 100% RH, 200/200 sccm).

Catalyst morphology and nanostructure: Oxygen reduction reaction (ORR)-active, platinum group metal (PGM)-free, and iron-free carbon catalysts were explored as a support for dispersing platinum nanoparticles, due to their beneficial nitrogen dopants, the richness of micropores and carbon defects, and the possible synergy between single metal sites and platinum for promoting the oxygen reduction reaction. One such material explored was the partially graphitic carbon support (Mn—N—C) derived from zeolitic imidazolate frameworks (ZIFs), which material has demonstrated a specific surface area up to 1500 m²/g with atomically dispersed nitrogen coordinated Mn sites (i.e., MnN₄). Another material explored was porous graphitic carbon (PGC) derived from polyaniline hydrogel, which material achieves an optimal balance between porosity (˜450 m²/g with dominant mesopores) and graphitization. In this example, platinum nanoparticles (NPs) were dispersed onto these two carbon-based supports using the ethylene glycol (EG) reduction method, followed by a post-heat treatment to improve stability. This method simplifies the synthesis process and guarantees that the high content of platinum (40 wt. %) can be achieved.

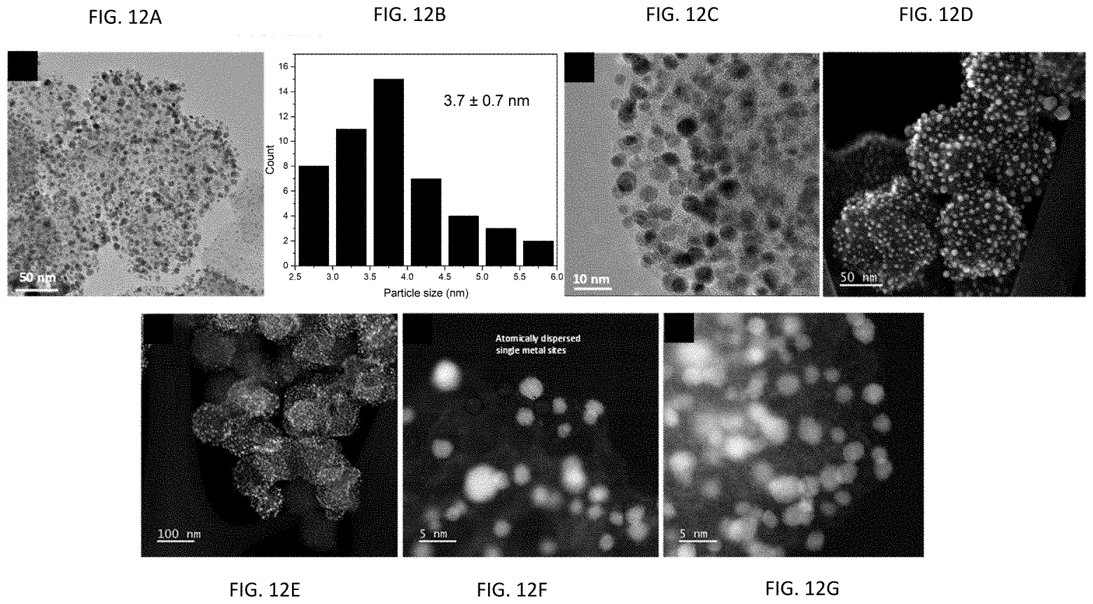

The morphology and nanostructure of the Mn—N—C supported platinum catalysts with a high content, denoted herein as Pt (40 wt. %)/Mn—N—C, were comprehensively studied using different electron microscopy techniques. According to transmission electron microscopy (TEM) images and platinum particle size distribution, it was determined that platinum nanoparticles with an average size of 3.7 nm were uniformly distributed on the polyhedron Mn—N—C carbon support particles (80-100 nm) (FIGS. 12A, 12B and 12C), thereby making such support particles an optimal primary particle for mass transfer and ionomer dispersion in electrodes. At the same time, some large platinum nanoparticles, i.e., close to 6 nm, were occasionally observed. A secondary electron (SE) image (FIG. 12D) indicates that the well-dispersed platinum nanoparticles were primarily located at the surface of the porous polyhedral carbon particles. It has been confirmed that the high surface area of the support favors the formation of small platinum particles because it favors the uniform adsorption and dispersion of platinum precursors during the synthesis and avoids the likely platinum agglomeration under subsequent high-temperature treatments. Scanning transmission electron microscopy (STEM) images (FIGS. 12E through 12G) further verify the uniformity of platinum nanoparticles dispersed onto the partially graphitized carbon. In addition to platinum nanoparticles, atomically dispersed single metal sites are apparent throughout the carbon particle (FIG. 12F), likely associated with the MnN₄ site embedded into the carbon support. Energy dispersive X-ray (EDX) analysis proves these well-dispersed platinum nanoparticles are deposited onto the Mn—N—C carbon particle that contains atomically dispersed Mn and N sites.

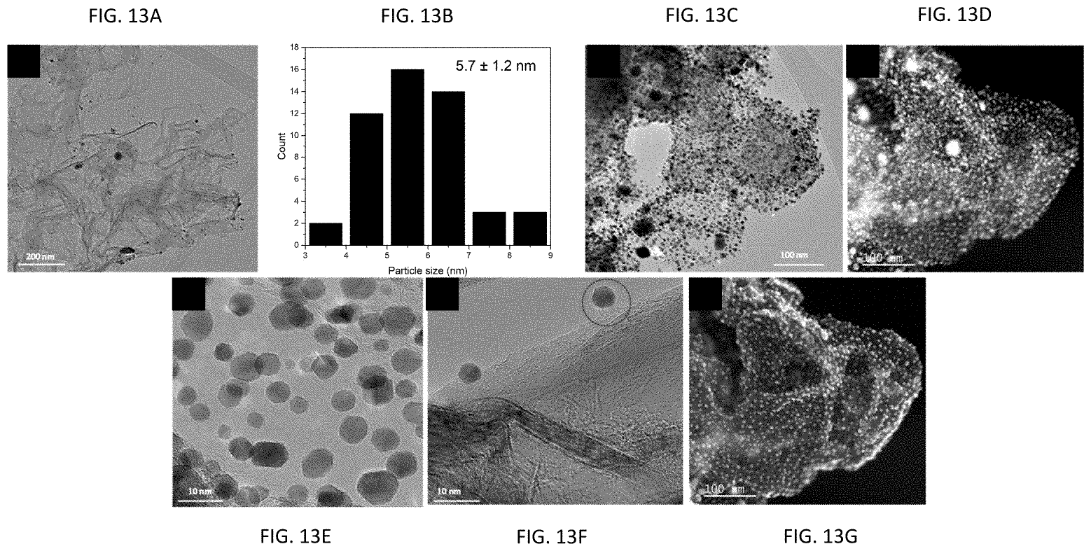

The morphology and nanostructures of the Pt (40 wt. %)/porous graphitic carbon (PGC) catalysts were also comprehensively studied using multiple electron microscopy. Unlike the well-defined polyhedral particles observed with the Mn—N—C support, the PGC presents a porous sheet-like morphology (FIG. 13A), which is potentially favorable for ionomer dispersion and mass transport due to significant mesopores. Overall, platinum nanoparticles were well-dispersed on the support, with a size distribution of 3-9 nm and an average of 5.7 nm (FIGS. 13B through 13E); however, occasionally, several large aggregates up to 20-30 nm were present. The enlarged areas in FIG. 13F clearly show the strong interaction between a single platinum nanoparticle and the carbon support, which is essential to enhance catalyst stability under fuel cell operating conditions. The secondary electron image (FIG. 13G) also indicates well-dispersed platinum nanoparticles located at the carbon surface. The relatively larger platinum particle sizes are likely due to the lower surface area and higher degree of graphitization of the porous graphitic carbon, relative to the Mn—N—C support. This significant difference between these two types of support (i.e., Mn—N—C and PGC) suggests that the carbon morphology and structure play an essential role in governing platinum nanoparticle sizes, dispersion, and their interaction with carbon supports. The high specific surface area and abundant carbon defects provide more anchoring sites to deposit platinum particles. By contrast, the higher graphitization structure leads to larger platinum particles and possible agglomeration but is essential for stability improvement, especially for challenging heavy-duty vehicle applications. Energy dispersive X-ray analysis indicated that C, N, and Mn are uniformly dispersed in the porous graphitic carbon support surrounding the platinum nanoparticles.

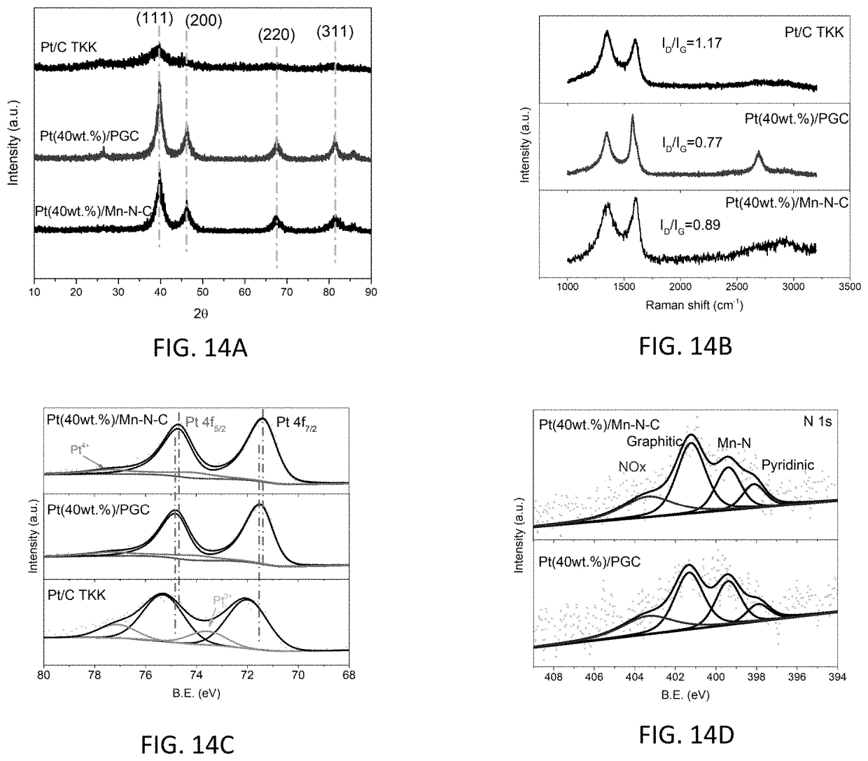

The crystal structure of the Pt (40 wt. %)/Mn—N—C catalyst, the Pt (40 wt. %)/PGC catalyst, and a commercial TKK catalyst (40 wt. % Pt/C) were compared using X-ray diffraction (XRD) patterns (FIG. 14A). All three catalysts showed four typical peaks at 39.8°, 46.3°, 67.5°, and 81.6°, which are assigned to (111), (200), (220), and (311) planes of platinum, respectively. There are no peak shifts observed for all catalysts, suggesting no alloy formation between platinum and manganese even after a post-treatment at 800° C. Compared to the other samples, the Pt (40 wt. %)/PGC catalyst exhibited sharper diffraction peaks, likely due to the largest platinum nanoparticles. To the contrary, the commercial TKK catalyst demonstrated the smallest platinum nanoparticles. As for the Raman spectra of these catalysts (FIG. 14B), the Pt(40 wt. %)/PGC catalyst presented the lowest I_{D}/I_{G} ratio of 0.77, an indicator of the highest degree of graphitization with dominant ordered sp² carbon. On the other hand, the commercial TKK catalyst exhibited the lowest graphitization degree with the largest I_{D}/I_{G} ratio of 1.12, indicating dominant amorphous carbon structures of the high-surface-area TKK carbon support.

FIGS. 14C and 14D compare the platinum 4 f and nitrogen 1 s X-ray photoelectron spectra, respectively, for the three catalysts using X-ray photoelectron spectroscopy (XPS). The platinum nanoparticles predominantly exhibited zero valences in the metallic form. The commercial TKK Pt/C catalyst demonstrated more content of oxidized platinum valance, likely due to the smallest particle sizes easily being oxidized when exposed to air. Importantly, an apparent negative shift was observed in the platinum 4 f binding energy for the Pt (40 wt. %)/Mn—N—C and the Pt (40 wt. %)/PGC catalysts, compared with the commercial TKK Pt/C catalyst. The increased electron density of platinum likely originates from a partial electron transfer from the nitrogen-doped carbon support to platinum, indicating the strengthened interactions between the carbon support and the platinum nanoparticles. The nitrogen dopants in the carbon support were also detected in both the Pt (40 wt. %)/Mn—N—C and Pt (40 wt. %)/PGC catalysts, as evidenced by the dominant N 1 s spectra of graphitic N (401.2 eV), M—N (399.4 eV), and pyridinic N (398.1 eV). It should be noted that the nitrogen-doped carbon support generally shows pyridinic N around 398.4 eV. It is apparent that the binding energy of N 1 s shifts negatively after platinum nanoparticle deposition, which is a result of interaction between the support and the platinum. Generally, the acid-base properties of the carbon support, associated with surface functionality and defects, affect the platinum nanoparticle growth mechanism and stability. The introduction of nitrogen dopants increases the Lewis basicity of the carbon surface, leading to the strong anchoring of platinum nanoparticles to the carbon. These results are also in good agreement with our previous density functional theory (DFT) calculations. See Qiao et al., “3D porous graphitic nanocarbon for enhancing the performance and durability of Pt catalysts: a balance between graphitization and hierarchical porosity, Energy & Environmental Science, 12:2830-2841 (2019). The electronegativity of nitrogen would increase the electron transfer from the carbon planes to platinum, which strengthens the interaction with the platinum.

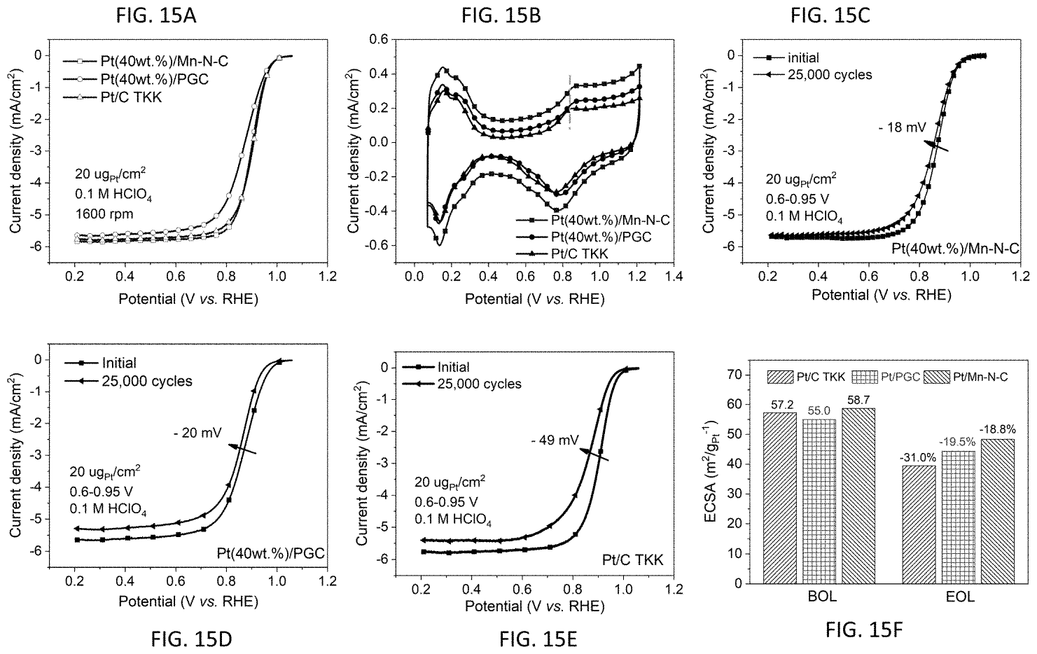

ORR activity and stability in aqueous electrolyte: Oxygen reduction reaction (ORR) activity and stability of the above-mentioned three platinum catalysts with 40 wt. % high content were studied using a rotating ring disk electrode (RRDE) in a 0.1 M HClO₄ electrolyte at room temperature (see FIGS. 15A and 15B). Among the three catalysts, the Pt (40 wt. %)/Mn—N—C catalyst exhibited similar oxygen reduction activity to the TKK 40 wt. % Pt/C catalyst, with a half-wave potential (E_{1/2}) of 0.89 V at a platinum loading of 20 μg/cm² and a rotating speed of 1600 rpm. Also, both catalysts showed comparable mass activities (MA) at 0.9 V, namely, 0.146 mA/μg_{Pt} for the Pt (40 wt. %)/Mn—N—C catalyst and 0.153 mA/μg_{Pt} for the TKK 40 wt. % Pt/C catalyst. By contrast, due to the lower surface area of its carbon support and due to its having the largest platinum nanoparticles, the Pt (40 wt. %)/PGC catalyst presented the lowest activity, with an E_{1/2} around 0.86 V and a mass activity of 0.09 mA/μg_{Pt}. Notably, the Mn—N—C support can act as a highly active oxygen reduction reaction catalyst with a half-wave potential of 0.81 V, due to its intrinsically active atomically dispersed N-coordinated MnN₄ sites. Such PGM-free single metal sites (e.g., MnN₄ and FeN₄) could promote the breaking of O—O bonds and optimize O₂ adsorption energy on platinum clusters, thereby improving the intrinsic activity of Pt. However, due to the slightly larger platinum nanoparticles (3-4 nm) of the Pt (40 wt. %)/Mn—N—C catalyst as compared to the TKK 40 wt % Pt/C catalyst (2-3 nm), the promotional roles of the Mn—N—C support to oxygen reduction reaction activity may be compromised and do not yield significantly enhanced catalytic activity. However, the primary benefits of the Mn—N—C support are the enhancement of catalyst stability and durability, which are discussed later. The Pt (40 wt. %)/Mn—N—C catalyst presents a similar electrochemically active surface area (ECSA) (58.7 m²/g_{Pt}) to the TKK 40 wt % Pt/C catalyst (57.2 m²/g_{Pt}) and a slightly larger ECSA than the Pt (40 wt. %)/PGC (55 m²/g_{Pt}). As illuminated in FIG. 15C, the favorable Mn—N—C carbon morphology exposes more platinum nanoparticles at the support surface. Notably, the relatively lower double-layer capacitance was observed with the TKK 40 wt. % Pt/C catalyst, suggesting the hydrophobic nature of the carbon support as compared to the Mn—N—C and the PGC supports. In addition, the platinum oxidation potential of the TKK 40 wt. % Pt/C catalyst is comparatively lower than that of the other two catalysts, due to its having the smallest platinum nanoparticles and its possible weak interactions with the support.

The catalyst durability was studied by potential cycling from 0.6-0.95 V vs. RHE (see FIGS. 15C, 15D and 15E). After the accelerated stress test (AST), the Pt (40 wt. %)/Mn—N—C and the Pt(40 wt. %)/PGC catalysts showed negligible kinetic activity loss, i.e., ΔE_{1/2}<20 mV. To the contrary, the TKK 40 wt. % Pt/C catalyst exhibited a 49 mV loss. There were changes in the electrochemically active surface areas (ECSAs) for the various catalysts after the 25,000 cycles accelerated stress test (AST). More specifically, the Pt/Mn—N—C and Pt/PGC catalysts lost 18.8% and 19.5% initial ECSAs, respectively. However, by contrast, the TKK Pt/C catalyst suffered more than a 30% loss of initial ECSA, which is inferior in durability even in an aqueous acidic electrolyte. A comparison of the aforementioned three catalysts is summarized in FIG. 15F.

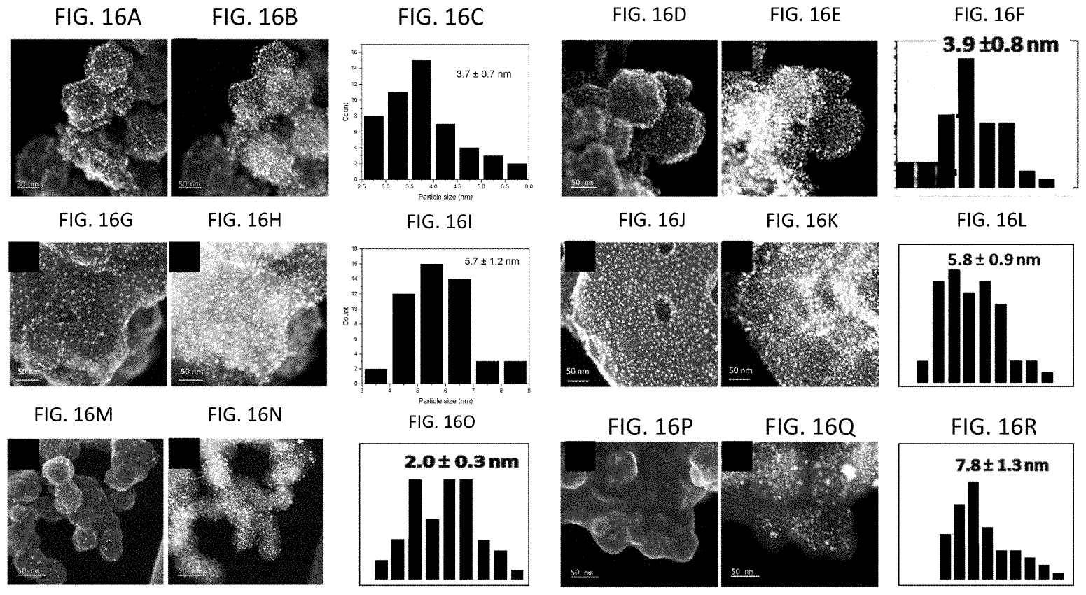

Catalyst degradation mechanisms: To understand the degradation mechanism of various Pt/C catalysts with a high content (40 wt. %), an analysis was conducted of platinum nanoparticles and carbon supports at the beginning of life (BOL) and at the end of life (EOL), said analysis using advanced electron microscopy techniques, including secondary electron (SE) and medium-angle annular dark-field-scanning transmission electron microscopy (MAADF-STEM) images. The SE images provide surface morphology and structures of these catalysts, while the MAADF-STEM images show the 2-dimensional projection of 3-dimensional objects. By comparing images from two techniques, one can identify whether platinum nanoparticles are still at the surface or not after the stability accelerated stress test (AST). By comparing FIGS. 16A and 16D, it is evident that the platinum nanoparticles are well-maintained at the Pt (40 wt. %)/Mn—N—C surface. The platinum nanoparticles barely show any severe agglomeration by comparing their MAADF-STEM images before and after the accelerated stress test (FIGS. 16B and 16E, with FIG. 16C showing the size distribution of platinum nanoparticles in the catalyst of FIG. 16B and with FIG. 16F showing the size distribution of platinum nanoparticles in the catalyst of FIG. 16E). These results indicate remarkable stability of the platinum nanoparticles during the accelerated stress test, likely due to the effects of the Mn—N—C support (i.e., optimal porosity, surface chemistry, and graphitization) and the strong interaction between platinum nanoparticles and the support. For the Pt (40 wt. %)/PGC catalyst, the platinum nanoparticle density and distribution are also well-maintained at the carbon surface (FIGS. 16G and 16J) similarly to that of the Mn—N—C support. The uniform platinum nanoparticle sizes and morphologies are also well-reserved after the accelerated stress test (FIGS. 16H and 16K, with FIG. 16I showing the size distribution of platinum nanoparticles in the catalyst of FIG. 16H and with FIG. 16L showing the size distribution of platinum nanoparticles in the catalyst of FIG. 16K), suggesting a strong interaction between the platinum nanoparticles and the carbon.

To the contrary, for the TKK 40 wt. % Pt/C sample, secondary electron images after the accelerated stress test indicate that the platinum nanoparticle density and coverage at the carbon surface are much lower than for the initial catalyst (FIGS. 16M and 16P). Also, medium-angle annular dark-field-scanning transmission electron microscopy (MAADF-STEM) images (see FIGS. 16N and 16Q, with FIG. 16O showing the size distribution of platinum nanoparticles in the catalyst of FIG. 16N and with FIG. 16R showing the size distribution of platinum nanoparticles in the catalyst of FIG. 16Q) indicate a severe agglomeration of platinum nanoparticles after the accelerated stress test, corresponding to the observed electrochemically active surface area (ECSA) loss and activity degradation. Notably, most platinum nanoparticles have been detached from the carbon surface during the accelerated stress test (FIG. 16P) although a significant number of nanoparticles were detected embedded in the carbon, as verified using the STEM image of FIG. 16Q. These electron microscopy analyses explain why the TKK 40 wt. % Pt/C catalyst undergoes a dramatic drop of kinetic activity and ECSA loss. Also, the possible corrosion of amorphous carbon around the platinum nanoparticles in the TKK catalyst could accelerate platinum dissolution and platinum nanoparticle detachment.

By contrast, the density of platinum nanoparticles at the surface and the original particle sizes can be well-reserved for the Mn—N—C support, which agrees with their minor activity losses. In fact, based on analysis, the elemental distribution of the Pt (40 wt. %)/Mn—N—C catalyst after the stability accelerated stress test shows that, in addition to the well-reserved fine platinum nanoparticles, carbon structures, N dopants, and atomically dispersed single Mn sites remain intact, verifying the excellent stability of the catalyst. The robust carbon structures of the Mn—N—C support could mitigate possible carbon corrosion and enhance the stability of platinum nanoparticles. Therefore, compared to the TKK high-surface-area carbon used for 40 wt % Pt/C catalyst, the Mn—N—C support is advanced to stabilize platinum nanoparticles during the stability accelerated stress test, likely due to strengthened interaction originating from the possible single metal site and N dopants in carbon.

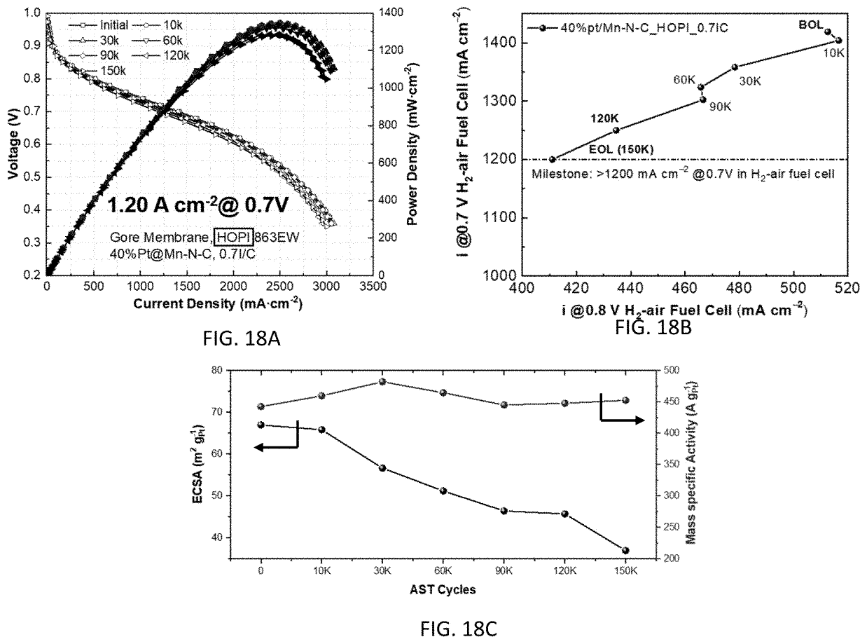

Fuel cell MEA performance: These above-discussed catalysts were studied in a solid-state polymer electrolyte-based membrane electrode assembly (MEA) as the cathode to evaluate their fuel cell performance. Unlike traditional ultra-low platinum group metal (PGM) MEAs, a high PGM loading (0.2 mg_{Pt}/cm²) for the cathode under high back pressure (250 kPa) was applied for the heavy-duty vehicle applications. It was clear that the Pt (40 wt. %)/Mn—N—C cathode exhibited the best fuel cell performance in terms of both kinetic region and mass transfer region (FIG. 18A). The MEA generated 1.61 A/cm² at 0.7 V, corresponding to a peak power density of 1.7 W/cm². The Pt (40 wt. %)/PGC cathode demonstrated a lower current density 1.25 A/cm² at 0.7 V and a reduced peak power density of 1.39 W/cm². In agreement with rotating disk electrode (RDE) tests, the relatively low performance compared to the Pt (40 wt. %)/Mn—N—C cathode is due to the larger platinum nanoparticles, low electrochemically active surface area (ECSA), and less porous carbon support. By contrast, the TKK Pt/C (40 wt. %) cathode exhibited the lowest fuel cell performance in a wide voltage range, especially a modest current density of 1.14 A/cm² at 0.7 V.

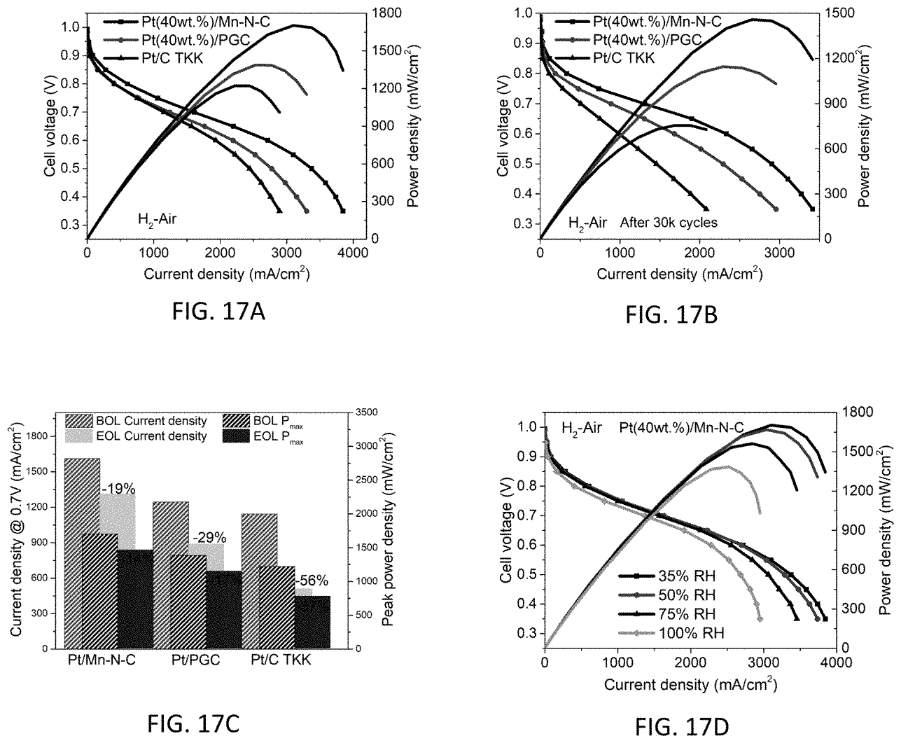

FIG. 17B further compares the MEA performance after 30,000 voltage cycles according to standard U.S. Department of Energy (DOE) PGM catalyst accelerated stress test protocols. (See Qiao et al., “Atomically dispersed single iron sites for promoting Pt and Pt₃Co fuel cell catalysts: performance and durability improvements,” Energy & Environmental Science, 14:4948-4960 (2021), which is incorporated herein by reference.) The Pt (40 wt. %)/Mn—N—C cathode in an MEA shows much-enhanced durability, retaining 1.31 A/cm² at 0.7 V, which is promising to approach the DOE target for heavy-duty vehicles (i.e., 1.07 A/cm² at 0.7 V after 150,000 cycles). Despite the relatively low performance, the Pt (40 wt. %)/PGC cathode also demonstrated good durability and was superior to the TKK cathode (0.88 A/cm² vs. 0.50 A/cm² at 0.7 V after the identical 30,000-cycle AST). FIG. 17C compares the beginning of life (BOL) and end of life (EOL) MEA performance for all three cathodes concerning current density at 0.7 V and peak power density. The Pt (40 wt. %)/Mn—N—C cathode exhibited the most durable behavior with only a 19% loss of current density at 0.7 V and a 14% loss of power density. The Pt (40 wt. %)/PGC cathode lost 30% current density at 0.7 V and 17% power density. By comparison, the TKK 40 wt. % Pt/C cathode showed a 56% loss of current density at 0.7 V and a 37% loss of power density after the identical accelerated stress test. As recommended by the DOE, after 150,000 voltage cycles, which is equivalent to a lifetime of 25,000 hours for heavy-duty vehicles, the MEA should retain 1.07 A/cm² at 0.7 V under heavy-duty vehicle conditions (0.3 mg_{Pt}/cm² in MEA and 250 Kpa air).

As heavy-duty vehicles are desirable to be operated at low relative humidity (RH), the effect of relative humidity on the MEA performance for the Pt (40 wt. %)/Mn—N—C cathode was also studied (FIG. 17D). The fuel cell tests used a 5 cm² differential cell at 80° C., flow rates of 500 sccm (H₂) and 2000 sccm (air), and backpressures of 250 kPa. The fabricated MEA consisted of a proton exchange membrane (Gore MX20.15, W. L. Gore & Associates, Inc., Newark, Del.), a Pt/C anode (0.1 mg_{Pt}/cm²), and 40 wt. % Pt/C cathode (0.2 mg_{Pt}/cm²). The best performance was achieved at 50% relative humidity for the cathode, which is more practical to operate MEA under lower relative humidity like 35%-50% relative humidity, close to humidity in ambient weather. By contrast, apparent water flooding occurs at 100% relative humidity at high and low voltage regions. It becomes severe in the high-current density range, likely due to the possible water flooding associated with abundant microporosity of the Mn—N—C support. The dependence of MEA performance on relative humidity suggests that optimizing electrode structure with tunable hydrophobicity can further improve MEA performance and durability.

Referring now to FIGS. 18A through 18C, the results of a long-term MEA stability test performed on a Pt (40 wt. %)/Mn—N—C integrated with a high oxygen permeability ionomer (HOPI) are shown. As can be seen, the MEA displayed remarkable durability over 150,000 accelerated stress test cycles. Also, although the electrochemically active surface area (ECSA) gradually decreased, the mass activity remained relative unchanged. The current density at 0.7 V gradually decreased from 1.42 A/cm² to 1.2 A/cm² after 150,000 cycles, displaying remarkable durability.

Additional advantages, features, and observations regarding the present invention are set forth below.
According to one embodiment, the present invention provides a new type of high-performance, low-PGM, fuel cell catalyst by integrating highly stable Pt or PtCo intermetallic nanoparticles and a promising PGM-free MnN₄ site-rich carbon catalyst. The high surface areas, porous morphologies, controlled graphitization degree, and adjustable carbon particle size dramatically improve Pt and PtCo nanoparticle dispersions with uniform and narrow size distribution, promoting high catalytic activity and Pt utilization. The dense MnN₄ sites likely significantly strengthen the interaction between Pt and carbon, thus preventing nanoparticle agglomeration which enhances catalyst electrochemically active surface area (ECSA) stability. Importantly, the MnN₄ sites around the Pt sites can weaken the adsorption of O₂ and intermediates during the oxygen reduction reaction (ORR), intrinsically improving the catalytic activity of Pt for the ORR.
Compared to the common solid solution A1-structure, PtCo intermetallics with strong Pt—M interaction either isotropically (in the case of cubic L1₂ structure formation) or anisotropically (in the case of tetragonal L1₀ or hexagonal structure formation) are particularly promising as new fuel cell catalysts due to their superior M-stabilization in corrosive ORR conditions. In this patent application, there is provided an effective approach to synthesizing, amongst other things, these two types of PtCo intermetallic catalysts using different atmospheres during the annealing treatment. Forming gas is favorable for forming the L1₀ PtCo structures whereas an argon atmosphere facilitates L1₂ Pt₃Co structures.
Comprehensive rotating disk electrode (RDE) and membrane electrode assembly (MEA) studies verify that a MnN₄-rich carbon support is superior to traditional nitrogen-doped carbon and carbon black with respect to ORR activity and stability. In particular, the Pt/MnN₄—C catalyst disclosed herein has achieved compelling activity and stability with a 30 mV positive shift in half-wave potential relative to a Pt/C catalyst and only 10 mV loss after 30,000 potential cycles. MEA performance further demonstrates outstanding mass activity at 0.9 V and durability, which has achieved the challenging Department of Energy targets by using Pt without alloying.
Two types of PtCo intermetallic catalysts on the MnN₄-carbon achieved a record ORR activity concerning half-wave potentials above 0.95 V, representing one of the most active PGM catalysts. Stability studies using rotating disk electrode (RDE) further demonstrate that the tetragonal L1₀ PtCo intermetallic catalyst is more stable than the cubic L1₂ Pt₃Co intermetallic catalyst. Unlike the observation from RDE tests in aqueous acidic electrolyte, the Pt₃Co/MnN₄—C performs better in MEAs than the PtCo/MnN₄—C with respect to mass activity and stability. The better-performing Pt₃Co/MnN₄ MEA reached a power density of 923 mW/cm² at 0.67 V and only lost 16 mV at 0.8 A/cm² after 30,000 voltage cycles in an MEA. Further engineering electrode structures by optimizing ionomer/carbon ratios can achieve an excellent balance of ORR mass activity, power density, and durability. L1₂ Pt₃Co@HS Mn—NC-800 achieved exceptional power density of 1132 mW/cm² at 0.67 V, exceeding the DOE target of 1000 mW/cm².
A new Pt catalyst with a high-content (40 wt. %) for possible heavy-duty vehicle (HDV) applications was successfully developed with remarkable MEA performance and durability by depositing platinum nanoparticles onto a unique Mn—N—C support, containing atomically dispersed and nitrogen coordinated single Mn sites. Despite the high Pt content, fine Pt NPs can be well-dispersed on the Mn—N—C support. The stability of the Pt/Mn—N—C catalyst is superior to a commercial Pt/C TKK (40 wt. %) catalyst under both rotating ring-disk electrode (RRDE) and MEA tests. In an aqueous acid electrolyte, after 30,000 potential cycles, the commercial TKK Pt/C catalyst underwent a significant degradation with a loss of 49 mV in half-wave potential due to the apparent agglomeration and fall-off of Pt NPs from the amorphous carbon surface. On the other hand, the Pt/Mn—N—C catalyst only showed a 18 mV loss, in which most Pt NPs remained at the carbon surface after the identical AST. The excellent support effort of Mn—N—C with much-strengthened interaction likely originates from high-surface-area, considerable graphitization, and dominant single metal site/N dopants. In particular, the high surface area of the Mn—N—C ensures that the Pt NPs can be uniformly distributed without any agglomeration. The robust carbon structures could mitigate possible carbon corrosion and enhance the stability of Pt NPs. The possible electron transfer from single Mn and N dopants further strengthens their interactions. Notably, another promising catalyst, in which Pt is deposited on a porous graphitic carbon (PGC) support, also exhibited good durability although its performance was limited by its low surface area, causing relatively larger Pt NPs.
The performance and durability of the Pt (40 wt. %)/Mn—N—C catalyst were successfully demonstrated in fuel cell MEAs under heavy-duty operating conditions (0.2 mg_{Pt}/cm² for the cathode under 250 Kpa air). The MEA initially generated 1.61 A/cm² at 0.7 V, corresponding to a peak power density of 1.7 W/cm². After 30,000 voltage cycles, according to standard DOE PGM catalyst AST protocols, the MEA still retained 1.31 A/cm² at 0.7 V, approaching the DOE target of 1.07 A/cm² at 0.7 V after 150,000 cycles.
Mn sites are very challenging to be doped into a carbon support, as compared to traditional Fe and Co sites. This is, in part, because, unlike Fe and Co ions, Mn ions cannot easily exchange the original Zn and form complexes with N in the ZIF-8 precursor. Only a low density of atomic Mn sites are introduced using a conventional one-step chemical doping. Due to a wide variety of Mn valences from 0 to +7, Mn aggregates easily form during the high-temperature carbonization even at a low content. Thus, achieving atomically dispersed MnN₄ sites with increased density is a very challenging task. Here, we disclose, in one embodiment, a catalyst with atomically dispersed MnN₄ sites obtained through a two-step synthesis strategy involving doping and adsorption processes by leveraging the unique properties of ZIF-8 precursors, which has been shown to effectively increase the active-site density. In the first step of synthesis, Mn ions are combined with Zn ions in an environmentally benign aqueous solution to prepare Mn-doped ZIF-8 precursors. After carbonization and acid leaching, the derived porous carbon is used as a host to adsorb additional Mn and N sources, followed by a subsequent thermal activation. This atomically dispersed Mn—N—C catalyst achieves extremely high surface areas 1500 m²/g and unique graphitic structures/morphologies for a desirable carbon support to design highly active and stable Pt and PtCo catalysts.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A hybrid catalyst suitable for use in an oxygen reduction reaction in a proton exchange membrane fuel cell, the hybrid catalyst comprising:
(a) a support, the support comprising an Mn—N—C support; and
(b) platinum-containing nanoparticles dispersed on the Mn—N—C support.

2. The hybrid catalyst as claimed in claim 1 wherein the Mn—N—C support comprises atomically dispersed and nitrogen coordinated MnN₄ moieties.

3. The hybrid catalyst as claimed in claim 1 wherein the platinum-containing nanoparticles have a particle size ranging from about 2 to 8 nm.

4. The hybrid catalyst as claimed in claim 1 wherein the Mn—N—C support has a particle size ranging from about 30 to 200 nm.

5. The hybrid catalyst as claimed in claim 1 wherein the platinum-containing nanoparticles are present with a loading ranging from about 10 to 60 wt. % against the Mn—N—C support.

6. The hybrid catalyst as claimed in claim 5 wherein the platinum-containing nanoparticles are present with a loading ranging from about 20 to 40 wt. % against the Mn—N—C support.

7. The hybrid catalyst as claimed in claim 6 wherein the platinum-containing nanoparticles are present with a loading of about 20 wt. % against the Mn—N—C support.

8. The hybrid catalyst as claimed in claim 6 wherein the platinum-containing nanoparticles are present with a loading of about 40 wt. % against the Mn—N—C support.

9. The hybrid catalyst as claimed in claim 1 wherein the platinum-containing nanoparticles comprise nanoparticles of a platinum alloy.

10. The hybrid catalyst as claimed in claim 9 wherein the platinum alloy is a platinum-cobalt alloy.

11. The hybrid catalyst as claimed in claim 10 wherein the platinum-cobalt alloy is a platinum-cobalt intermetallic alloy.

12. The hybrid catalyst as claimed in claim 11 wherein the platinum-cobalt intermetallic alloy is a cubic L1₂ Pt₃Co alloy.

13. The hybrid catalyst as claimed in claim 11 wherein the platinum-cobalt intermetallic alloy is a tetragonal L1₀ PtCo alloy.

14. The hybrid catalyst as claimed in claim 1 wherein the platinum-containing nanoparticles are platinum nanoparticles.

15. The hybrid catalyst as claimed in claim 1 wherein the Mn—N—C support further comprises a sulfur dopant.

16. The hybrid catalyst as claimed in claim 1 wherein the Mn—N—C support is devoid of a dopant other than the platinum-containing nanoparticles.

17. A membrane electrode assembly suitable for use in a proton exchange membrane fuel cell, the membrane electrode assembly comprising:
(a) a proton exchange membrane, the proton exchange membrane having first and second faces on opposite sides;
(b) a cathode operatively coupled to the first face of the proton exchange membrane, the cathode comprising the hybrid catalyst of claim 1; and
(c) an anode operatively coupled to the second face of the proton exchange membrane.

18. A method of preparing a hybrid catalyst comprising platinum nanoparticles dispersed on an Mn—N—C support, the method comprising the steps of:
(a) combining a quantity of a hexachloroplatinic acid solution with a quantity of an Mn—N—C support to form a mixture;
(b) sonicating the mixture in an ice bath;
(c) then, freeze-drying the product of step (b);
(d) then, calcinating the product of step (c) under a forming gas; and
(e) then, heating the product of step (d).

19. A method of preparing a hybrid catalyst comprising nanoparticles of a cubic L1₂ Pt₃Co alloy dispersed on an Mn—N—C support, the method comprising the steps of:
(a) combining quantities of a hexachloroplatinic acid solution, CoCl₂.6H₂O, and an Mn—N—C support to form a mixture;
(b) sonicating the mixture in an ice bath;
(c) then, freeze-drying the product of step (b);
(d) then, calcinating the product of step (c) under a forming gas;
(e) then, heating the product of step (d);
(f) then, leaching the product of step (e) in perchloric acid;
(g) then, vacuum-drying the product of step (f); and
(h) then, post-treating the product of step (g) at an elevated temperature under argon.

20. A method of preparing a hybrid catalyst comprising nanoparticles of a tetragonal L1₀ PtCo alloy dispersed on an Mn—N—C support, the method comprising the steps of:
(a) combining quantities of a hexachloroplatinic acid solution, CoCl₂.6H₂O, and an Mn—N—C support to form a mixture;
(b) sonicating the mixture in an ice bath to form a homogeneous complex suspension;
(c) then, quickly freezing the product of step (b), followed by freeze-drying overnight;
(d) then, heating the product of step (c) under forming gas flow;
(e) then, allowing the product of step (d) to cool to room temperature;
(f) then, heating the product of step (e) under forming gas;
(g) then, leaching the product of step (f) in perchloric acid; and
(h) then, post-treating the product of step (g) at an elevated temperature under argon.
